(19) United States
(12) Patent Application Publication
(10) Pub. No.: US 2026/0111706 A1
(43) Pub. Date: Apr. 23, 2026

(54) Method, System, and Computer Program Product for Fairness Without Demographics Through Shared Latent Space-Based Debiasing

(71) Applicant: Visa International Service Association, San Francisco, CA (US)

(72) Inventors: Rashidul Islam, Atlanta, GA (US); Huiyuan Chen, San Jose, CA (US); Yiwei Cai, Mercer Island, WA (US)

(21) Appl. No.: 19/127,846

(22) PCT Filed: Aug. 13, 2024
(86) PCT No.: PCT/US2024/042055

§ 371 Date: May 7, 2025

Related U.S. Application Data
(60) Provisional application No. 63/532,510, filed on Aug. 14, 2023.

(51) Int. Cl. G06N 3/045; G06N 3/094; G06Q 30/0204

(52) U.S. Cl. CPC G06N 3/045; G06N 3/094; G06Q 30/0204

(57) ABSTRACT

Methods, systems, and computer program products are provided for shared latent space-based debiasing. An example system includes at least one processor configured to: transform data from each of a target domain, which lacks protected features, and a separate source domain, which contains these features, into correlated latent representations; jointly train a cross-domain protected group estimator on the representations; and debias a downstream machine learning model an adversarial learning technique that leverages the group estimator.

### CROSS REFERENCE TO RELATED APPLICATIONS

This application is the United States national phase of International Application No. PCT/US24/42055 filed Aug. 13, 2024, and claims priority to U.S. Patent Provisional Application Ser. No. 63/532,510, filed Aug. 14, 2023, the disclosures of which are hereby incorporated by reference in their entireties.

### BACKGROUND

### 1. Technical Field

This disclosure relates to fairness in machine learning and, in some non-limiting embodiments or aspects, to methods, systems, and computer program products for a shared latent space-based debiasing (SLSD) technique to provide fairness in machine learning without access to demographics.

### 2. Technical Considerations

Recent years have witnessed a surge in evidence suggesting that, when trained on historical data without necessary precautions, machine learning (ML) systems can inadvertently exhibit discrimination across various demographic groups. Such bias can have a serious impact on diverse aspects of everyday life, ranging from movie recommendations to more serious domains like credit scoring and criminal recidivism prediction. Consequently, significant research has been directed towards developing and enforcing various mathematical constructs of bias and fairness in algorithms. However, a common constraint in these existing works is their dependence on the ML model's access to protected attributes such as race and gender, during their training.

In practical contexts, factors such as privacy concerns, legal constraints, and regulatory measures often limit the acquisition or use of protected attributes. For example, Title VII of the 1964 Civil Rights Act prevents employers from inquiring about an applicant's gender and race. Similarly, the EU GDPR imposes constraints on collecting such data. Yet, the imperative to achieve fairness is undiminished, especially to counteract harmful biases against specific protected groups. For example, the CFPB mandates creditors to implement fair lending practices but concurrently restricts them from collecting demographic details from applicants. This paradox is well-acknowledged within the artificial intelligence (AI) community, spanning both the public sector and industry, and highlights the urgent need of ensuring fairness without demographics.

Existing solutions to this conundrum mainly adopt the idea of Rawlsian max-min fairness that maximizes the utility such as accuracy for the most disadvantaged group without demographic information. These methods effectively tackle representation bias adhering to the infra-marginality principle, which posits that a system is biased if and only if its behavior exhibits disparities greater than those in society or the underlying data. However, experiments reveal that they frequently fail to satisfy established parity-based group fairness standards, like demographic parity or the legally recognized 80%-Rule, as specified in the Code of Federal Regulations (Equal Employment Opportunity Commission 1978). Besides addressing representation bias, parity-based fairness notions also capture other critical biases such as societal and intentional prejudices, and societal disadvantages, all of which can often skew the behavior of ML systems. Furthermore, groups or regions found by these existing fair algorithms without demographics may not necessarily align with the intended protected attributes. For example, a model may be optimized to maximize utility in terms of race when the desired protected attribute is gender.

### SUMMARY

Accordingly, provided are improved methods, systems, and computer program products for shared latent space-based debiasing.

According to non-limiting embodiments or aspects, provided is a method, including: obtaining, with at least one processor, a target data set including a plurality of first individuals, wherein each first individual is associated with a set of first non-protected features and a first binary class label; obtaining, with the at least one processor, a source dataset including a plurality of second individuals, wherein each second individual is associated with a set of second non-protected features, a second binary class label, and a protected feature; jointly training, with the at least one processor, a target encoder on the target data set and a source encoder on the source data set; training, with the at least one processor, a protected group estimator model on an output of the source encoder; after jointly training the target encoder on the target data set and the source encoder on the source dataset and training the protected group estimator model on the output of the source encoder, training, with the at least one processor, the target encoder on the target data set and the protected group estimator model on an output of the target encoder; after training the target encoder and the protected group estimator model on the target data set, debiasing, with the at least one processor, a classifier model by: training the classifier model on the target data set; generating, with the target encoder and the protected group estimator model, based on the target data set, a plurality of protected features for the plurality of first individuals; training an adversarial network on an output of the classifier model; and for each first individual, debiasing the classifier model according to an objective function that depends on the output of the classifier associated with that first individual, the first binary class label associated with that first individual, the output of the adversarial network associated with that first individual, and a protected feature of the plurality of protected features associated with that first individual.

In some non-limiting embodiments or aspects, the plurality of first individuals is different than plurality of second individuals, and wherein the set of first non-protected features is different than the set of second non-protected features.

In some non-limiting embodiments or aspects, jointly training, with the at least one processor, the target encoder on the target data set and the source encoder on the source dataset includes: sampling, from the target data set, a first subset of the first individuals associated with the first binary class label including a positive and a second subset of the first individuals associated with the first binary class label including a negative; sampling, from the source data set, a first subset of the second individuals associated with the second binary class label including a positive and a second subset of the second individuals associate with the second binary class label including a negative; simultaneously encoding (i) instances of the set of first non-protected features associated with the first subset of the first individuals with the target encoder and (ii) instances of the set of second non-protected features and the protected feature associated with the first subset of the second individuals with the source encoder; and simultaneously encoding (a) instances of the set of first non-protected features associated with the second subset of the first individuals with the target encoder and (b) instances of the set of second non-protected features and the protected feature associated with the second subset of the second individuals with the source encoder.

In some non-limiting embodiments or aspects, jointly training, with the at least one processor, the target encoder on the target data set and the source encoder on the source dataset includes optimizing a canonical correlation loss L_{CCA} loss according to the following Equation:

$${ℒ}_{CCA} ( {z}_{𝒮} , {z}_{𝒯} ) = - {\sum }_{i = 1}^{{n}_{𝒮}^{+}} cov ( {z}_{𝒮}^{+ ( i )} , {z}_{𝒯}^{+ ( i )} ) / \sqrt{var ( {z}_{𝒮}^{+ ( i )} ) var ( {z}_{𝒯}^{+ ( i )} )} - {\sum }_{i = 1}^{{n}_{𝒮}^{-}} cov ( {z}_{𝒮}^{- ( i )} , {z}_{𝒯}^{- ( i )} ) / \sqrt{var ( {z}_{𝒮}^{- ( i )} ) var ( {z}_{𝒯}^{- ( i )} )}$$

where E_{∂} is the source encoder, [symbol] is an output of the source encoder as [symbol] =E_{∂}( [symbol] ) for an instance of non-protected features [symbol] , E_{∂} is the target encoder, [symbol] is an output of the target encoder as [symbol] =E_{∂}( [symbol] ) for an instance of protected features [symbol] ⊂ [symbol] and [symbol] ⊂ [symbol] are positive subsets of [symbol] and [symbol] of first and second individuals respectively, [symbol] and [symbol] are negative counterparts of the positive subsets, [symbol] =E_{∂}( [symbol] ) is positive instance of non-protected features transformed by the source encoder, [symbol] =E_{∂}( [symbol] ) is a positive instance of protected features transformed by the target encoder, [symbol] =E_{∂}( [symbol] ) is a negative instance of non-protected features transformed by the source encoder, [symbol] =E_{∂}( [symbol] ) is a negative instance of protected features transformed by the target encoder, wherein minimizing the canonical correlation loss L_{CCA} is equivalent to maximizing according to the following Equation:

$${max}_{ϑ , φ} Tr ( {z}_{𝒮}^{⊤} , {z}_{𝒯} ) s . t . {z}_{𝒮}^{⊤} {z}_{𝒮} = {z}_{𝒯}^{⊤} {z}_{𝒯} = I ,$$

where [symbol] =[ [symbol] ] and [symbol] =[ [symbol] ] are corresponding concatenations.

In some non-limiting embodiments or aspects, training, with the at least one processor, the protected group estimator model on based the output of the source encoder includes minimizing a cross-entropy loss L_{CE} according to the following Equation:

$${ℒ}_{CE} ( {\hat{a}}_{𝒮} , {a}_{𝒮} ) = - {\sum }_{i = 1}^{{n}_{𝒮}} {\sum }_{k = 1}^{K} {a}_{𝒮 , k}^{( i )} log ( {\hat{a}}_{𝒮 , k}^{( i )} )$$

where G_{ψ} is the protected group estimator model, [symbol] =σ(G_{ψ}( [symbol] )) is a softmax output of the protected group estimator model for an output of the source encoder as [symbol] for the instance of non-protected features [symbol] with a protected group [symbol] , and K is a number of groups in a domain of the source dataset, such that minimizing the canonical correlation loss L_{CCA} is further defined according to the following equation:

$${min}_{ϑ , φ , Ψ} {ℒ}_{CCA} ( {z}_{𝒮} , {z}_{𝒯} ) + {ℒ}_{CE} ( {\hat{a}}_{𝒮} , {a}_{𝒮} ) .$$

In some non-limiting embodiments or aspects, training, with the at least one processor, the target encoder on the target data set and the protected group estimator model on the output of the target encoder includes: computing a consistency loss as a Kullback-Leibler (KL) divergence according to the following Equation:

$${ℒ}_{KLD} ( {{a}^{\hat{\sim}}}_{𝒯0} , {\hat{a}}_{𝒯0} ) = {\hat{a}}_{𝒯0} \cdot ( log {\hat{a}}_{𝒯0} - log {{a}^{\hat{\sim}}}_{𝒯0} )$$

where [symbol] =α(G_{ψ}(G [symbol] )), [symbol] =σ(G_{ψ}( [symbol] /t)), t is a softmax temperature or function; and minimizing a cross-entropy loss L_{CE} according to the following Equation:

$${min}_{φ , Ψ} {ℒ}_{CE} ( {\hat{a}}_{𝒯1} , {a}_{𝒯1}^{*} ) + {ℒ}_{KLD} ( {{a}^{\hat{\sim}}}_{𝒯0} , {\hat{a}}_{𝒯0} )$$

where [symbol] =σ(G_{ψ}( [symbol] )), m is a masking index, [symbol] /2 is a top half of first individuals with highest probabilities across estimated group categories for which the masking index is set as m=1 to extract corresponding samples as [symbol] = [symbol] [m=1], [symbol] = [symbol] [m=0] is the remaining samples for which the masking index is set as m=0, [symbol] =σ(G_{ψ}(E_{φ}( [symbol] )), where [symbol] is a first group of the first individuals extracted by a mask, and [symbol] is a second group of the individuals remaining after the mask, and pseudo-group labels are generated as [symbol] =arg [symbol] .

In some non-limiting embodiments or aspects, a learning objective for debiasing the classifier model is a min-max problem defined according to the following Equation:

$${min}_{Θ} {max}_{Φ} {ℒ}_{CE} ( {\hat{y}}_{𝒯} , {y}_{𝒯} ) - {λℒ}_{CE} ( {\hat{a}}_{𝒯} , {a}_{𝒯}^{*} )$$

where M_{Θ} is the classifier model which takes [symbol] as input and predicts an outcome [symbol] for each first individual, who belongs to the unknown protected group [symbol] , λ is a hyperparameter, and D_{φ}, is the adversarial network that receives the classifier's predictions [symbol] =σ(M_{Θ}( [symbol] )) as input predict groups as [symbol] =σ(D_{φ}( [symbol] )), and wherein group assignments can be estimated according to the following Equation:

$${a}_{𝒯}^{*} = arg max {G}_{Ψ} ( {E}_{φ} ( {x}_{𝒯} ) ) .$$

According to non-limiting embodiments or aspects, provided is a system including: at least one processor configured to: obtain a target data set including a plurality of first individuals, wherein each first individual is associated with a set of first non-protected features and a first binary class label; obtain a source dataset including a plurality of second individuals, wherein each second individual is associated with a set of second non-protected features, a second binary class label, and a protected feature; jointly train a target encoder on the target data set and a source encoder on the source data set; train a protected group estimator model on an output of the source encoder; after jointly training the target encoder on the target data set and the source encoder on the source dataset and training the protected group estimator model on the output of the source encoder, train the target encoder on the target data set and the protected group estimator model on an output of the target encoder; after training the target encoder and the protected group estimator model on the target data set, debias a classifier model by: training the classifier model on the target data set; generating, with the target encoder and the protected group estimator model, based on the target data set, a plurality of protected features for the plurality of first individuals; training an adversarial network on an output of the classifier model; and for each first individual, debiasing the classifier model according to an objective function that depends on the output of the classifier associated with that first individual, the first binary class label associated with that first individual, the output of the adversarial network associated with that first individual, and a protected feature of the plurality of protected features associated with that first individual.

In some non-limiting embodiments or aspects, the plurality of first individuals is different than plurality of second individuals, and wherein the set of first non-protected features is different than the set of second non-protected features.

In some non-limiting embodiments or aspects, the at least one processor is configured to jointly train the target encoder on the target data set and the source encoder on the source dataset by: sampling, from the target data set, a first subset of the first individuals associated with the first binary class label including a positive and a second subset of the first individuals associated with the first binary class label including a negative; sampling, from the source data set, a first subset of the second individuals associated with the second binary class label including a positive and a second subset of the second individuals associate with the second binary class label including a negative; simultaneously encoding (i) instances of the set of first non-protected features associated with the first subset of the first individuals with the target encoder and (ii) instances of the set of second non-protected features and the protected feature associated with the first subset of the second individuals with the source encoder; and simultaneously encoding (a) instances of the set of first non-protected features associated with the second subset of the first individuals with the target encoder and (b) instances of the set of second non-protected features and the protected feature associated with the second subset of the second individuals with the source encoder.

In some non-limiting embodiments or aspects, the at least one processor is configured to jointly train the target encoder on the target data set and the source encoder on the source dataset by optimizing a canonical correlation loss L_{CCA} loss according to the following Equation:

$${ℒ}_{CCA} ( {z}_{𝒮} , {z}_{𝒯} ) = - {\sum }_{i = 1}^{{n}_{𝒮}^{+}} cov ( {z}_{𝒮}^{+ ( i )} , {z}_{𝒯}^{+ ( i )} ) / \sqrt{var ( {z}_{𝒮}^{+ ( i )} ) var ( {z}_{𝒯}^{+ ( i )} )} - {\sum }_{i = 1}^{{n}_{𝒮}^{-}} cov ( {z}_{𝒮}^{- ( i )} , {z}_{𝒯}^{- ( i )} ) / \sqrt{var ( {z}_{𝒮}^{- ( i )} ) var ( {z}_{𝒯}^{- ( i )} )}$$

where E_{∂} is the source encoder, [symbol] is an output of the source encoder as [symbol] =E_{∂}( [symbol] ) for an instance of non-protected features [symbol] , E_{∂} is the target encoder, [symbol] is an output of the target encoder as [symbol] =E_{φ}( [symbol] ) for an instance of protected features [symbol] ⊂ [symbol] and [symbol] ⊂ [symbol] are positive subsets of [symbol] and [symbol] of first and second individuals, respectively, [symbol] and [symbol] are negative counterparts of the positive subsets, [symbol] =E_{∂}( [symbol] ) is positive instance of non-protected features transformed by the source encoder, [symbol] =E_{φ}( [symbol] ) is a positive instance of protected features transformed by the target encoder, [symbol] =E_{∂}( [symbol] ) is a negative instance of non-protected features transformed by the source encoder, [symbol] =E_{φ}( [symbol] ) is a negative instance of protected features transformed by the target encoder, wherein minimizing the canonical correlation loss L_{CCA} is equivalent to maximizing according to the following Equation:

$${max}_{ϑ , φ} Tr ( {z}_{𝒮}^{⊤} , {z}_{𝒯} ) s . t . {z}_{𝒮}^{⊤} {z}_{𝒮} = {z}_{𝒯}^{⊤} {z}_{𝒯} = I ,$$

where [symbol] =[ [symbol] ] and [symbol] =[ [symbol] ] are corresponding concatenations.

In some non-limiting embodiments or aspects, the at least one processor is configured to train the protected group estimator model on based the output of the source encoder by minimizing a cross-entropy loss L_{CE} according to the following Equation:

$${ℒ}_{CE} ( {\hat{a}}_{𝒮} , {a}_{𝒮} ) = - {\sum }_{i = 1}^{{n}_{𝒮}} {\sum }_{k = 1}^{K} {a}_{𝒮 , k}^{( i )} log ( {\hat{a}}_{𝒮 , k}^{( i )} )$$

where G_{Ψ} is the protected group estimator model, [symbol] =σ(G_{ψ}( [symbol] )) is a softmax output of the protected group estimator model for an output of the source encoder as [symbol] for the instance of non-protected features [symbol] with a protected group [symbol] , and K is a number of groups in a domain of the source dataset, such that minimizing the canonical correlation loss L_{CCA} is further defined according to the following equation:

$${min}_{ϑ , φ , Ψ} {ℒ}_{CCA} ( {z}_{𝒮} , {z}_{𝒯} ) + {ℒ}_{C E} ( {\hat{a}}_{𝒮} , {a}_{𝒮} ) .$$

In some non-limiting embodiments or aspects, the at least one processor is configured to train the target encoder on the target data set and the protected group estimator model on the output of the target encoder by: computing a consistency loss as a Kullback-Leibler (KL) divergence according to the following Equation:

$${ℒ}_{KLD} ( {\hat{\tilde{a}}}_{𝒯0} , {\hat{a}}_{𝒯0} ) = {\hat{a}}_{𝒯0} \cdot ( log {\hat{a}}_{𝒯0} - log {\hat{\tilde{a}}}_{𝒯0} )$$

where [symbol] =σ(G_{Ψ}( [symbol] )), [symbol] =σ(G_{Ψ}( [symbol] /t)), t is a softmax temperature or function; and minimizing a cross-entropy loss L_{CE} according to the following Equation:

$${min}_{φ , Ψ} {ℒ}_{CE} ( {\hat{a}}_{𝒯1} , {a}_{𝒯1}^{*} ) + {ℒ}_{KLD} ( {\hat{\tilde{a}}}_{𝒯0} , {\hat{a}}_{𝒯0} )$$

where [symbol] =σ(G_{Ψ}( [symbol] )), m is a masking index, n [symbol] /2 is a top half of first individuals with highest probabilities across estimated group categories for which the masking index is set as m=1 to extract corresponding samples as [symbol] = [symbol] [m=1], [symbol] = [symbol] [m=0] is the remaining samples for which the masking index is set as m=0, [symbol] =σ(G_{Ψ}(E_{φ}( [symbol] )), where [symbol] is a first group of the first individuals extracted by a mask, and [symbol] is a second group of the first individuals remaining after the mask, and pseudo-group labels are generated as [symbol] =arg [symbol] .

In some non-limiting embodiments or aspects, a learning objective for debiasing the classifier model is a min-max problem defined according to the following Equation:

$${min}_{Θ} {max}_{Φ} {ℒ}_{CE} ( {\hat{y}}_{𝒯} , {y}_{𝒯} ) - {λℒ}_{CE} ( {\hat{a}}_{𝒯} , {a}_{𝒯}^{*} )$$

where M_{Θ} is the classifier model which takes x_{τ} as input and predicts an outcome [symbol] for each first individual, who belongs to the unknown protected group [symbol] , λ is a hyperparameter, and D_{φ} is the adversarial network that receives the classifier's predictions [symbol] =σ(M_{Θ}( [symbol] )) as input predict groups as [symbol] =ø(D_{φ}( [symbol] )), and wherein group assignments can be estimated according to the following Equation:

$${a}_{𝒯}^{*} = arg max {G}_{Ψ} ( {E}_{φ} ( {x}_{𝒯} ) ) .$$

According to non-limiting embodiments or aspects, provided is a computer program product including at least one non-transitory computer-readable medium including program instructions that, when executed by at least one processor, cause the at least one processor to: obtain a target data set including a plurality of first individuals, wherein each first individual is associated with a set of first non-protected features and a first binary class label; obtain a source dataset including a plurality of second individuals, wherein each second individual is associated with a set of second non-protected features, a second binary class label, and a protected feature; jointly train a target encoder on the target data set and a source encoder on the source data set; train a protected group estimator model on an output of the source encoder; after jointly training the target encoder on the target data set and the source encoder on the source dataset and training the protected group estimator model on the output of the source encoder, train the target encoder on the target data set and the protected group estimator model on an output of the target encoder; after training the target encoder and the protected group estimator model on the target data set, debias a classifier model by: training the classifier model on the target data set; generating, with the target encoder and the protected group estimator model, based on the target data set, a plurality of protected features for the plurality of first individuals; training an adversarial network on an output of the classifier model; and for each first individual, debiasing the classifier model according to an objective function that depends on the output of the classifier associated with that first individual, the first binary class label associated with that first individual, the output of the adversarial network associated with that first individual, and a protected feature of the plurality of protected features associated with that first individual.

In some non-limiting embodiments or aspects, the plurality of first individuals is different than plurality of second individuals, and wherein the set of first non-protected features is different than the set of second non-protected features.

In some non-limiting embodiments or aspects, the program instructions, when executed by the at least one processor, cause the at least one processor to jointly train the target encoder on the target data set and the source encoder on the source dataset by: sampling, from the target data set, a first subset of the first individuals associated with the first binary class label including a positive and a second subset of the first individuals associated with the first binary class label including a negative; sampling, from the source data set, a first subset of the second individuals associated with the second binary class label including a positive and a second subset of the second individuals associate with the second binary class label including a negative; simultaneously encoding (i) instances of the set of first non-protected features associated with the first subset of the first individuals with the target encoder and (ii) instances of the set of second non-protected features and the protected feature associated with the first subset of the second individuals with the source encoder; and simultaneously encoding (a) instances of the set of first non-protected features associated with the second subset of the first individuals with the target encoder and (b) instances of the set of second non-protected features and the protected feature associated with the second subset of the second individuals with the source encoder.

In some non-limiting embodiments or aspects, the program instructions, when executed by the at least one processor, cause the at least one processor to jointly train the target encoder on the target data set and the source encoder on the source dataset by optimizing a canonical correlation loss L_{CCA} loss according to the following Equation:

$${ℒ}_{CCA} ( {z}_{𝒮} , {z}_{𝒯} ) = - {\sum }_{i = 1}^{{n}_{𝒮}^{+}} cov ( {z}_{𝒮}^{+ ( i )} , {z}_{𝒯}^{+ ( i )} ) / \sqrt{var ( {z}_{𝒮}^{+ ( i )} ) var ( {z}_{𝒯}^{+ ( i )} )} - {\sum }_{i = 1}^{{n}_{𝒮}^{-}} cov ( {z}_{𝒮}^{- ( i )} , {z}_{𝒯}^{- ( i )} ) / \sqrt{var ( {z}_{𝒮}^{- ( i )} ) var ( {z}_{𝒯}^{- ( i )} )}$$

where E_{∂} is the source encoder, [symbol] is an output of the source encoder as [symbol] =E_{∂}( [symbol] ) for an instance of non-protected features [symbol] , E_{φ} is the target encoder, [symbol] is an output of the target encoder as [symbol] =E_{φ}( [symbol] ) for an instance of protected features [symbol] ⊂ [symbol] and [symbol] ⊂ [symbol] are positive subsets of [symbol] and [symbol] of first and second individuals, respectively, [symbol] and [symbol] are negative counterparts of the positive subsets, [symbol] =E_{∂}( [symbol] ) is positive instance of non-protected features transformed by the source encoder, [symbol] =E_{φ}( [symbol] ) is a positive instance of protected features transformed by the target encoder, [symbol] =E_{∂}( [symbol] ) is a negative instance of non-protected features transformed by the source encoder, [symbol] =E_{φ}( [symbol] ) is a negative instance of protected features transformed by the target encoder, wherein minimizing the canonical correlation loss L_{CCA} is equivalent to maximizing according to the following Equation:

$${max}_{ϑ , φ} Tr ( {z}_{𝒯}^{T} , {z}_{𝒯} ) s . t . {z}_{𝒮}^{T} {z}_{𝒮} = {Z}_{𝒯}^{T} {Z}_{𝒯} = I ,$$

where [symbol] =[ [symbol] ] and [symbol] =[ [symbol] ] are corresponding concatenations.

In some non-limiting embodiments or aspects, the program instructions, when executed by the at least one processor, cause the at least one processor to train the protected group estimator model on based the output of the source encoder by minimizing a cross-entropy loss L_{CE} according to the following Equation:

$${ℒ}_{CE} ( {\hat{a}}_{𝒮} , {a}_{𝒮} ) = - {\sum }_{i = 1}^{{n}_{𝒮}} {\sum }_{k = 1}^{K} {a}_{𝒮 , k}^{( i )} log ( {\hat{a}}_{𝒮 , k}^{( i )} )$$

where G_{Ψ} is the protected group estimator model, [symbol] =σ(G_{ψ}( [symbol] )) is a softmax output of the protected group estimator model for an output of the source encoder as [symbol] for the instance of non-protected features [symbol] with a protected group [symbol] , and K is a number of groups in a domain of the source dataset, such that minimizing the canonical correlation loss L_{CCA} is further defined according to the following equation:

$${min}_{ϑ , φ , Ψ} {ℒ}_{CCA} ( {z}_{𝒮} , {z}_{𝒯} ) + {ℒ}_{CE} ( {\hat{a}}_{𝒮} , {a}_{𝒮} ) .$$

In some non-limiting embodiments or aspects, the program instructions, when executed by the at least one processor, cause the at least one processor to train the target encoder on the target data set and the protected group estimator model on the output of the target encoder by: computing a consistency loss as a Kullback-Leibler (KL) divergence according to the following Equation:

$${ℒ}_{KLD} ( {\hat{\tilde{a}}}_{𝒯0} , {\hat{a}}_{𝒯0} ) = {\hat{a}}_{𝒯0} \cdot ( log {\hat{a}}_{𝒯0} - log {\hat{\tilde{a}}}_{𝒯0} )$$

where [symbol] =σ(G_{Ψ}( [symbol] )), [symbol] =σ(G_{Ψ}( [symbol] /t)), t is a softmax temperature or function; and minimizing a cross-entropy loss L_{CE} according to the following Equation:

$${min}_{φ , Ψ} {ℒ}_{CE} ( {\hat{a}}_{𝒯1} , {a}_{𝒯1}^{*} ) + {ℒ}_{KLD} ( {\hat{\tilde{a}}}_{𝒯0} , {\hat{a}}_{𝒯0} )$$

where [symbol] =α(G_{Ψ}( [symbol] )), m is a masking index, [symbol] /2 is a top half of first individuals with highest probabilities across estimated group categories for which the masking index is set as m=1 to extract corresponding samples as [symbol] = [symbol] [m=1], [symbol] = [symbol] [m=0] the remaining samples for which the masking index is set as m=0, [symbol] =σ(G_{Ψ}( [symbol] ))), where [symbol] is a first group of the first individuals extracted by a mask, and [symbol] is a second group of the first individuals remaining after the mask, and pseudo-group labels are generated as [symbol] =arg [symbol] , and
wherein a learning objective for debiasing the classifier model is a min-max problem defined according to the following Equation:

$${min}_{Θ} {max}_{Φ} {ℒ}_{C E} ( {\hat{y}}_{𝒯} , {y}_{𝒯} ) - λ {ℒ}_{C E} ( {\hat{a}}_{𝒯} , {a}_{𝒯}^{*} )$$

where M_{Θ} is the classifier model which takes [symbol] as input and predicts an outcome [symbol] for each first individual, who belongs to the unknown protected group [symbol] , λ is a hyperparameter, and D_{φ}is the adversarial network that receives the classifier's predictions [symbol] =σ(M_{Θ}( [symbol] )) as input predict groups as [symbol] =σ(D_{φ}( [symbol] )), and wherein group assignments can be estimated according to the following Equation:

$${a}_{𝒯}^{*} = arg max {G}_{Ψ} ( {E}_{φ} ( {x}_{𝒯} ) ) .$$

Further non-limiting embodiments or aspects are set forth in the following numbered clauses:

Clause 1: A method, comprising: obtaining, with at least one processor, a target data set including a plurality of first individuals, wherein each first individual is associated with a set of first non-protected features and a first binary class label; obtaining, with the at least one processor, a source dataset including a plurality of second individuals, wherein each second individual is associated with a set of second non-protected features, a second binary class label, and a protected feature; jointly training, with the at least one processor, a target encoder on the target data set and a source encoder on the source data set; training, with the at least one processor, a protected group estimator model on an output of the source encoder; after jointly training the target encoder on the target data set and the source encoder on the source dataset and training the protected group estimator model on the output of the source encoder, training, with the at least one processor, the target encoder on the target data set and the protected group estimator model on an output of the target encoder; after training the target encoder and the protected group estimator model on the target data set, debiasing, with the at least one processor, a classifier model by: training the classifier model on the target data set; generating, with the target encoder and the protected group estimator model, based on the target data set, a plurality of protected features for the plurality of first individuals; training an adversarial network on an output of the classifier model; and for each first individual, debiasing the classifier model according to an objective function that depends on the output of the classifier associated with that first individual, the first binary class label associated with that first individual, the output of the adversarial network associated with that first individual, and a protected feature of the plurality of protected features associated with that first individual.

Clause 2: The method of clause 1, wherein the plurality of first individuals is different than plurality of second individuals, and wherein the set of first non-protected features is different than the set of second non-protected features.

Clause 3: The method of clause 1 or 2, wherein jointly training, with the at least one processor, the target encoder on the target data set and the source encoder on the source dataset includes: sampling, from the target data set, a first subset of the first individuals associated with the first binary class label including a positive and a second subset of the first individuals associated with the first binary class label including a negative; sampling, from the source data set, a first subset of the second individuals associated with the second binary class label including a positive and a second subset of the second individuals associate with the second binary class label including a negative; simultaneously encoding (i) instances of the set of first non-protected features associated with the first subset of the first individuals with the target encoder and (ii) instances of the set of second non-protected features and the protected feature associated with the first subset of the second individuals with the source encoder; and simultaneously encoding (a) instances of the set of first non-protected features associated with the second subset of the first individuals with the target encoder and (b) instances of the set of second non-protected features and the protected feature associated with the second subset of the second individuals with the source encoder.

Clause 4. The method of any of clauses 1-3, wherein jointly training, with the at least one processor, the target encoder on the target data set and the source encoder on the source dataset includes optimizing a canonical correlation loss L_{CCA} loss according to the following Equation:

$$\begin{matrix}{ℒ}_{CCA} ( {z}_{δ} , {z}_{𝒯} ) = - {{\sum }^{{n}_{δ}^{+}}}_{i = 1} cov ( {z}_{δ}^{+ ( i )} , {z}_{𝒯}^{+ ( i )} ) / \sqrt{var ( {z}_{δ}^{+ ( i )} ) var ( {z}_{δ}^{+ ( i )} )} \\ - {\sum }_{i = 1}^{n {-}_{δ}} cov ( {z}_{δ}^{- ( i )} , {z}_{𝒯}^{- ( i )} ) / \sqrt{var ( {z}_{δ}^{- ( i )} ) var ( {z}_{𝒯}^{- ( i )} )}\end{matrix}$$

where E_{∂} is the source encoder, [symbol] is an output of the source encoder as [symbol] =E_{∂}( [symbol] ) for an instance of non-protected features [symbol] , E_{φ} is the target encoder, [symbol] is an output of the target encoder as [symbol] =E_{φ}( [symbol] ) for an instance of protected features [symbol] ⊂ [symbol] and [symbol] ⊂ [symbol] are positive subsets of [symbol] and [symbol] of first and second individuals, respectively, [symbol] and [symbol] are negative counterparts of the positive subsets, [symbol] =E_{∂}( [symbol] ) is positive instance of non-protected features transformed by the source encoder, [symbol] =E_{φ}( [symbol] ) is a positive instance of protected features transformed by the target encoder, [symbol] =E_{∂}( [symbol] ) is a negative instance of non-protected features transformed by the source encoder, [symbol] =E_{φ}( [symbol] ) is a negative instance of protected features transformed by the target encoder, wherein minimizing the canonical correlation loss L_{CCA} is equivalent to maximizing according to the following Equation:

$${max}_{ϑ , φ} Tr ( {z}_{δ}^{T} , {z}_{𝒯} ) s . t . {z}_{δ}^{T} {z}_{δ} = {z}_{𝒯}^{T} {z}_{𝒯} = I ,$$

where [symbol] =[ [symbol] ] and [symbol] =[ [symbol] ] are corresponding concatenations.

Clause 5: The method of any of clauses 1-4, wherein training, with the at least one processor, the protected group estimator model on based the output of the source encoder includes minimizing a cross-entropy loss L_{CE} according to the following Equation:

$${ℒ}_{CE} ( {\hat{a}}_{δ} , {a}_{δ} ) = - {{\sum }^{{n}_{δ}}}_{i = 1} {{\sum }^{K}}_{k = 1} {a}_{δ , k}^{( i )} log ( {\hat{a}}_{δ , k}^{( i )} )$$

where G_{Ψ} is the protected group estimator model, [symbol] =σ(G_{Ψ}( [symbol] )) is a softmax output of the protected group estimator model for an output of the source encoder as [symbol] for the instance of non-protected features [symbol] with a protected group [symbol] , and K is a number of groups in a domain of the source dataset, such that minimizing the canonical correlation loss L_{CCA} is further defined according to the following equation:

$${max}_{ϑ , φ , Ψ} {ℒ}_{CCA} ( {z}_{δ} , {z}_{𝒯} ) + {ℒ}_{CE} ( {\hat{a}}_{δ} , {a}_{δ} ) .$$

Clause 6: The method of any of clauses 1-5, wherein training, with the at least one processor, the target encoder on the target data set and the protected group estimator model on the output of the target encoder includes: computing a consistency loss as a Kullback-Leibler (KL) divergence according to the following Equation:

$${ℒ}_{KLD} ( {\hat{\tilde{a}}}_{𝒯 0} , {\hat{a}}_{𝒯0} ) = {\hat{a}}_{𝒯 0} \cdot ( log {\hat{a}}_{𝒯 0} - log {\hat{\tilde{a}}}_{𝒯 0} )$$

where [symbol] =σ(G_{Ψ}( [symbol] )), [symbol] =σ(G_{Ψ}( [symbol] /t)), t is a softmax temperature or function; and minimizing a cross-entropy loss L_{CE} according to the following Equation:

$${max}_{ϑ , Ψ} {ℒ}_{CE} ( {\hat{a}}_{𝒯 1} , {a}_{𝒯 1}^{*} ) + {ℒ}_{KLD} ( {\hat{\tilde{a}}}_{𝒯 0} , {\hat{a}}_{𝒯 0} )$$

where [symbol] =σ(G_{Ψ}( [symbol] )), m is a masking index, [symbol] /2 is a top half of first individuals with highest probabilities across estimated group categories for which the masking index is set as m=1 to extract corresponding samples as [symbol] = [symbol] [m=1], [symbol] = [symbol] [m=0] is the remaining samples for which the masking index is set as m=0, [symbol] =σ(G_{Ψ}(E_{φ}( [symbol] )), where [symbol] is a first group of the first individuals extracted by a mask, and [symbol] is a second group of the first individuals remaining after the mask, and pseudo-group labels are generated as [symbol] =arg [symbol] .

Clause 7: The method of any of clauses 1-6, wherein a learning objective for debiasing the classifier model is a min-max problem defined according to the following Equation:

$${min}_{Θ} {max}_{Φ} {ℒ}_{CE} ( {\hat{y}}_{𝒯} , {y}_{𝒯} ) - λ {ℒ}_{CE} ( {\hat{a}}_{𝒯} , {a}_{𝒯}^{*} )$$

where M_{Θ}is the classifier model which takes [symbol] as input and predicts an outcome [symbol] for each first individual, who belongs to the unknown protected group [symbol] , λ is a hyperparameter, and D_{φ} is the adversarial network that receives the classifier's predictions [symbol] =σ(M_{Θ}( [symbol] ) as input predict groups as [symbol] =σ(D_{φ}( [symbol] )), and wherein group assignments can be estimated according to the following Equation:

$${a}_{𝒯}^{*} = arg max {G}_{Ψ} ( {E}_{φ} ( {x}_{𝒯} ) ) .$$

Clause 8: A system, comprising: at least one processor configured to: obtain a target data set including a plurality of first individuals, wherein each first individual is associated with a set of first non-protected features and a first binary class label; obtain a source dataset including a plurality of second individuals, wherein each second individual is associated with a set of second non-protected features, a second binary class label, and a protected feature; jointly train a target encoder on the target data set and a source encoder on the source data set; train a protected group estimator model on an output of the source encoder; after jointly training the target encoder on the target data set and the source encoder on the source dataset and training the protected group estimator model on the output of the source encoder, train the target encoder on the target data set and the protected group estimator model on an output of the target encoder; after training the target encoder and the protected group estimator model on the target data set, debias a classifier model by: training the classifier model on the target data set; generating, with the target encoder and the protected group estimator model, based on the target data set, a plurality of protected features for the plurality of first individuals; training an adversarial network on an output of the classifier model; and for each first individual, debiasing the classifier model according to an objective function that depends on the output of the classifier associated with that first individual, the first binary class label associated with that first individual, the output of the adversarial network associated with that first individual, and a protected feature of the plurality of protected features associated with that first individual.

Clause 9: The system of clause 8, wherein the plurality of first individuals is different than plurality of second individuals, and wherein the set of first non-protected features is different than the set of second non-protected features.

Clause 10: The system of clause 8 or 9, wherein the at least one processor is configured to jointly train the target encoder on the target data set and the source encoder on the source dataset by: sampling, from the target data set, a first subset of the first individuals associated with the first binary class label including a positive and a second subset of the first individuals associated with the first binary class label including a negative; sampling, from the source data set, a first subset of the second individuals associated with the second binary class label including a positive and a second subset of the second individuals associate with the second binary class label including a negative; simultaneously encoding (i) instances of the set of first non-protected features associated with the first subset of the first individuals with the target encoder and (ii) instances of the set of second non-protected features and the protected feature associated with the first subset of the second individuals with the source encoder; and simultaneously encoding (a) instances of the set of first non-protected features associated with the second subset of the first individuals with the target encoder and (b) instances of the set of second non-protected features and the protected feature associated with the second subset of the second individuals with the source encoder.

Clause 11: The system of any of clauses 8-10, wherein the at least one processor is configured to jointly train the target encoder on the target data set and the source encoder on the source dataset by optimizing a canonical correlation loss L_{CCA} loss according to the following Equation:

$$\begin{matrix}{ℒ}_{CCA} ( {z}_{δ} , {z}_{𝒯} ) = - {{\sum }^{{n}_{δ}^{+}}}_{i = 1} cov ( {z}_{δ}^{+ ( i )} , {z}_{𝒯}^{+ ( i )} ) / \sqrt{var ( {z}_{δ}^{+ ( i )} ) var ( {z}_{δ}^{+ ( i )} )} \\ - {\sum }_{i = 1}^{n {-}_{δ}} cov ( {z}_{δ}^{- ( i )} , {z}_{𝒯}^{- ( i )} ) / \sqrt{var ( {z}_{δ}^{- ( i )} ) var ( {z}_{𝒯}^{- ( i )} )}\end{matrix}$$

where E_{∂} is the source encoder, [symbol] is an output of the source encoder as [symbol] =E_{∂}( [symbol] ) for an instance of non-protected features [symbol] , E_{φ} is the target encoder, [symbol] is an output of the target encoder as [symbol] =E_{φ}( [symbol] ) for an instance of protected features [symbol] ⊂ [symbol] and [symbol] [symbol] are positive subsets of [symbol] and [symbol] of first and second individuals, respectively, [symbol] and [symbol] are negative counterparts of the positive subsets, [symbol] =E_{∂}( [symbol] ) is positive instance of non-protected features transformed by the source encoder, [symbol] =E_{φ}( [symbol] ) is a positive instance of protected features transformed by the target encoder, [symbol] =E_{∂}( [symbol] ) is a negative instance of non-protected features transformed by the source encoder, [symbol] =E_{φ}( [symbol] ) is a negative instance of protected features transformed by the target encoder, wherein minimizing the canonical correlation loss L_{CCA} is equivalent to maximizing according to the following Equation

$${max}_{ϑ , φ} Tr ( {z}_{δ}^{T} , {z}_{𝒯} ) s . t . {z}_{δ}^{T} {z}_{δ} = {z}_{δ}^{T} {z}_{𝒯} = I ,$$

where [symbol] =[ [symbol] ] and [symbol] =[ [symbol] ] are corresponding concatenations.

Clause 12: The system of any of clauses 8-11, wherein the at least one processor is configured to train the protected group estimator model on based the output of the source encoder by minimizing a cross-entropy loss L_{CE} according to the following Equation:

$${ℒ}_{CE} ( {\hat{a}}_{δ} , {a}_{δ} ) = - {{\sum }^{{n}_{δ}}}_{i = 1} {{\sum }^{K}}_{k = 1} {a}_{δ , k}^{( i )} log ( {\hat{a}}_{δ , k}^{( i )} )$$

where G_{Ψ} is the protected group estimator model, [symbol] =α(G_{Ψ}( [symbol] )) is a softmax output of the protected group estimator model for an output of the source encoder as [symbol] for the instance of non-protected features [symbol] with a protected group [symbol] , and K is a number of groups in a domain of the source dataset, such that minimizing the canonical correlation loss L_{CCA} is further defined according to the following equation:

$${max}_{ϑ , φ , Ψ} {ℒ}_{CCA} ( {z}_{δ} , {z}_{𝒯} ) + {ℒ}_{CE} ( {\hat{a}}_{δ} , {a}_{δ} ) .$$

Clause 13. The system of any of clauses 8-12, wherein the at least one processor is configured to train the target encoder on the target data set and the protected group estimator model on the output of the target encoder by: computing a consistency loss as a Kullback-Leibler (KL) divergence according to the following Equation:

$${ℒ}_{KLD} ( {\hat{\tilde{a}}}_{𝒯 0} , {\hat{a}}_{𝒯 0} ) = {\hat{a}}_{𝒯 0} \cdot ( log {\hat{a}}_{𝒯 0} - log {\hat{\tilde{a}}}_{𝒯 0} )$$

where [symbol] =σ(G_{Ψ}( [symbol] )), [symbol] =σ(G_{Ψ}( [symbol] /t)), t is a softmax temperature or function; and minimizing a cross-entropy loss L_{CE} according to the following Equation:

$${max}_{ϑ , Ψ} {ℒ}_{CE} ( {\hat{a}}_{𝒯 1} , {a}_{𝒯 1}^{*} ) + {ℒ}_{KLD} ( {\hat{\tilde{a}}}_{𝒯 0} , {\hat{a}}_{𝒯 0} )$$

where [symbol] =α(G_{Ψ}( [symbol] )), m is a masking index, [symbol] /2 is a top half of first individuals with highest probabilities across estimated group categories for which the masking index is set as m=1 to extract corresponding samples as [symbol] = [symbol] [m=1], [symbol] = [symbol] [m=0] is the remaining samples for which the masking index is set as m=0, [symbol] =σ(G_{Ψ}(E_{φ}( [symbol] ))), where [symbol] is a first group of the first individuals extracted by a mask, and [symbol] is a second group of the first individuals remaining after the mask, and pseudo-group labels are generated as [symbol] =arg [symbol] .

Clause 14: The system of any of clauses 8-13, wherein a learning objective for debiasing the classifier model is a min-max problem defined according to the following Equation:

$${min}_{Θ} {max}_{Φ} {ℒ}_{CE} ( {\hat{y}}_{𝒯} , {y}_{𝒯} ) - {λℒ}_{CE} ( {\hat{a}}_{𝒯} , {a}_{𝒯}^{*} )$$

where M_{Θ}is the classifier model which takes [symbol] as input and predicts an outcome [symbol] for each first individual, who belongs to the unknown protected group [symbol] , λ is a hyperparameter, and D_{φ}, is the adversarial network that receives the classifier's predictions [symbol] =σ(M_{Θ}( [symbol] )) as input predict groups as [symbol] =σ(D_{φ}( [symbol] ), and wherein group assignments can be estimated according to the following Equation:

$${a}_{𝒯}^{*} = arg max {G}_{Ψ} ( {E}_{φ} ( {x}_{𝒯} ) ) .$$

Clause 15. A computer program product comprising at least one non-transitory computer-readable medium including program instructions that, when executed by at least one processor, cause the at least one processor to: obtain a target data set including a plurality of first individuals, wherein each first individual is associated with a set of first non-protected features and a first binary class label; obtain a source dataset including a plurality of second individuals, wherein each second individual is associated with a set of second non-protected features, a second binary class label, and a protected feature; jointly train a target encoder on the target data set and a source encoder on the source data set; train a protected group estimator model on an output of the source encoder; after jointly training the target encoder on the target data set and the source encoder on the source dataset and training the protected group estimator model on the output of the source encoder, train the target encoder on the target data set and the protected group estimator model on an output of the target encoder; after training the target encoder and the protected group estimator model on the target data set, debias a classifier model by: training the classifier model on the target data set; generating, with the target encoder and the protected group estimator model, on the target data set, a plurality of protected features for the plurality of first individuals; training an adversarial network on an output of the classifier model; and for each first individual, debiasing the classifier model according to an objective function that depends on the output of the classifier associated with that first individual, the first binary class label associated with that first individual, the output of the adversarial network associated with that first individual, and a protected feature of the plurality of protected features associated with that first individual.

Clause 16: The computer program product of clause 15, wherein the plurality of first individuals is different than plurality of second individuals, and wherein the set of first non-protected features is different than the set of second non-protected features.

Clause 17: The computer program product of clause 15 or 16, wherein the program instructions, when executed by the at least one processor, cause the at least one processor to jointly train the target encoder on the target data set and the source encoder on the source dataset by: sampling, from the target data set, a first subset of the first individuals associated with the first binary class label including a positive and a second subset of the first individuals associated with the first binary class label including a negative; sampling, from the source data set, a first subset of the second individuals associated with the second binary class label including a positive and a second subset of the second individuals associate with the second binary class label including a negative; simultaneously encoding (i) instances of the set of first non-protected features associated with the first subset of the first individuals with the target encoder and (ii) instances of the set of second non-protected features and the protected feature associated with the first subset of the second individuals with the source encoder; and simultaneously encoding (a) instances of the set of first non-protected features associated with the second subset of the first individuals with the target encoder and (b) instances of the set of second non-protected features and the protected feature associated with the second subset of the second individuals with the source encoder.

Clause 18: The computer program product of any of clauses 15-17, wherein the program instructions, when executed by the at least one processor, cause the at least one processor to jointly train the target encoder on the target data set and the source encoder on the source dataset by optimizing a canonical correlation loss L_{CCA} loss according to the following Equation:

$${ℒ}_{CCA} ( {z}_{𝒮} , {z}_{𝒯} ) = - {\sum }_{i = 1}^{{n}_{𝒮}^{+}} cov ( {z}_{𝒮}^{+ ( i )} , {z}_{𝒯}^{+ ( i )} ) / \sqrt{var ( {z}_{𝒮}^{+ ( i )} ) var ( {z}_{𝒯}^{+ ( i )} )} - {\sum }_{i = 1}^{{n}_{𝒮}^{-}} cov ( {z}_{𝒮}^{- ( i )} , {z}_{𝒯}^{- ( i )} ) / \sqrt{var ( {z}_{𝒮}^{- ( i )} ) var ( {z}_{𝒯}^{- ( i )} )}$$

where E_{∂} is the source encoder, [symbol] is an output of the source encoder as [symbol] =E_{∂}( [symbol] ) for an instance of non-protected features [symbol] , E_{φ} is the target encoder, [symbol] is an output of the target encoder as [symbol] =E_{φ}( [symbol] ) for an instance of protected features [symbol] ⊂ [symbol] and [symbol] ⊂ [symbol] are positive subsets of [symbol] and [symbol] of first and second individuals, respectively, [symbol] and [symbol] are negative counterparts of the positive subsets, [symbol] =E_{∂}( [symbol] ) is positive instance of non-protected features transformed by the source encoder, [symbol] =E_{φ}( [symbol] ) is a positive instance of protected features transformed by the target encoder, [symbol] =E_{∂}( [symbol] ) is a negative instance of non-protected features transformed by the source encoder, [symbol] =E_{φ}( [symbol] ) is a negative instance of protected features transformed by the target encoder, wherein minimizing the canonical correlation loss L_{CCA} is equivalent to maximizing according to the following Equation:

$${max}_{ϑ , φ} Tr ( {z}_{𝒮}^{T} , {z}_{𝒯} ) s . t . {z}_{𝒮}^{T} {z}_{𝒮} = {z}_{𝒯}^{T} {z}_{𝒯} = I ,$$

where [symbol] =[ [symbol] ] and [symbol] =[ [symbol] ] are corresponding concatenations.

Clause 19: The computer program product of any of clauses 15-18, wherein the program instructions, when executed by the at least one processor, cause the at least one processor to train the protected group estimator model on based the output of the source encoder by minimizing a cross-entropy loss L_{CE} according to the following Equation:

$${ℒ}_{CE} ( {\hat{a}}_{𝒮} , {a}_{𝒮} ) = - {\sum }_{i = 1}^{{n}_{S}} {\sum }_{k = 1}^{K} {a}_{𝒮 , k}^{( i )} log ( {\hat{a}}_{𝒮 , k}^{( i )} )$$

where G_{Ψ} is the protected group estimator model, [symbol] =σ(G_{Ψ}(G_{Ψ}( [symbol] )) is a softmax output of the protected group estimator model for an output of the source encoder as [symbol] for the instance of non-protected features [symbol] with a protected group [symbol] , and K is a number of groups in a domain of the source dataset, such that minimizing the canonical correlation loss L_{CCA} is further defined according to the following equation:

$${min}_{ϑ , φ , Ψ} {ℒ}_{CCA} ( {z}_{𝒮} , {z}_{𝒯} ) + {ℒ}_{CE} ( {\hat{a}}_{𝒮} , {a}_{𝒮} ) .$$

Clause 20. The computer program product of any of clauses 15-19, wherein the program instructions, when executed by the at least one processor, cause the at least one processor to train the target encoder on the target data set and the protected group estimator model on the output of the target encoder by: computing a consistency loss as a Kullback-Leibler (KL) divergence according to the following Equation:

$${ℒ}_{KLD} ( {\hat{\tilde{a}}}_{𝒯0} , {\hat{a}}_{𝒯0} ) = {\hat{a}}_{𝒯0} \cdot ( log {\hat{a}}_{𝒯0} - log {\hat{\tilde{a}}}_{𝒯0} )$$

where [symbol] =σ(G_{Ψ}( [symbol] )), [symbol] =σ(G_{Ψ}( [symbol] /t)), t is a softmax temperature or function; and minimizing a cross-entropy loss L_{CE} according to the following Equation:

$${min}_{φ , Ψ} {ℒ}_{CE} ( {\hat{a}}_{𝒯1} , {a}_{𝒯1}^{*} ) + {ℒ}_{KLD} ( {\hat{\tilde{a}}}_{𝒯0} , {\hat{a}}_{𝒯0} )$$

where [symbol] =σ(G_{Ψ}( [symbol] ), m is a masking index, [symbol] /2 is a top half of first individuals with highest probabilities across estimated group categories for which the masking index is set as m=1 to extract corresponding samples as [symbol] = [symbol] [m=1], [symbol] = [symbol] [m=0] is the remaining samples for which the masking index is set as m=0, [symbol] =α(G_{Ψ}(E_{φ}( [symbol] ))), where [symbol] is a first group of the first individuals extracted by a mask, and [symbol] is a second group of the first individuals remaining after the mask, and pseudo-group labels are generated as [symbol] =arg [symbol] , and
wherein a learning objective for debiasing the classifier model is a min-max problem defined according to the following Equation:

$${min}_{Θ} {max}_{Φ} {ℒ}_{CE} ( {\hat{y}}_{𝒯} , {y}_{𝒯} ) - {λℒ}_{CE} ( {\hat{a}}_{𝒯} , {a}_{𝒯}^{*} )$$

where M_{Θ}is the classifier model which takes [symbol] as input and predicts an outcome [symbol] for each first individual, who belongs to the unknown protected group [symbol] , λ is a hyperparameter, and D_{φ} is the adversarial network that receives the classifier's predictions [symbol] =σ(M_{Θ}( [symbol] )) as input predict groups as [symbol] =σ(D_{φ}( [symbol] )), and wherein group assignments can be estimated according to the following Equation:

$${a}_{𝒯}^{*} = arg max {G}_{Ψ} ( {E}_{φ} ( {x}_{𝒯} ) ) .$$

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of an electronic payment processing network, according to some non-limiting embodiments or aspects;

FIG. 2 is a schematic diagram of example components of one or more devices of FIG. 1, according to some non-limiting embodiments or aspects;

FIG. 3 is a flow diagram of a method for shared latent space-based debiasing (SLSD), according to some non-limiting embodiments or aspects;

FIG. 4A is a computational graph of a method for (SLSD), according to some non-limiting embodiments or aspects;

FIG. 4B is a computational graph of a method for relaxed-shared latent space debiasing (R-SLSD), according to some non-limiting embodiments or aspects;

FIG. 5 is a table including average performance metrics for example experiments with standard deviations across runs;

FIG. 6 is graphs of group fairness metrics for example experiments;

FIG. 7 is graphs comparing cross-validation grid search analysis of example experiments for SLSD and R-SLSD models according to non-limiting embodiments or aspects and an adversarial debiasing model (ADM);

FIG. 8 is graphs showing protected group estimation of example experiments comparing SLSD and R-SLSD models according to non-limiting embodiments or aspects with a fully supervised model;

FIG. 9 is a table including average performance metrics for an extreme experimental scenario;

FIG. 10 is graphs of fairness metrics for additional example experiments;

FIG. 11 is graphs comparing cross-validation grid search analysis of additional example experiments for SLSD and R-SLSD models according to non-limiting embodiments or aspects and an ADM;

FIGS. 12A and 12B are graphs comparing cross-validation grid search analysis of additional example experiments for SLSD and R-SLSD models according to non-limiting embodiments or aspects and Distributionally robust optimization (DRO) and adversarially re-weighted learning (ARL);

FIG. 13 is a table showing a summary of datasets for example experiments;

FIG. 14 includes pseudocode for protected group estimations in SLSD;

FIG. 15 includes pseudocode for protected group estimation in R-SLSD; and

FIG. 16 includes pseudocode for debiasing of a downstream model in SLSD and R-SLSD.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “real-time” refers to performance of a task or tasks during another process or before another process is completed. For example, a real-time inference may be an inference that is obtained from a model before a payment transaction is authorized, completed, and/or the like.

A number of studies have subsequently demonstrated the harmful and pervasive nature of societal biases in machine learning (ML). Addressing these concerns, there's been a surge in research to define fairness, typically divided into three categories: 1) individual fairness which aims to ensure similar outcomes for similar individuals, 2) group fairness which advocates outcome parity across protected groups, and 3) max-min fairness which attempts to improve minimum utility across groups. Non-limiting embodiments or aspects of the present disclosure may primarily focus on group fairness due to practical challenges in individual similarity determination and max-min notion's gaps in addressing societal stereotypes. There are various existing techniques to improve fairness, from penalizing violations and imposing fairness constraints to fair data transformations and adversarial debiasing. However, these existing approaches require the availability of protected attributes, which are often missing in practical applications.

Achieving fairness in the absence of demographic data is an emerging and complex challenge. A common strategy is to use proxy features or to operate under the assumption of slightly perturbed protected features. However, such proxies, vulnerable to estimation bias, are not consistently found in data and can be difficult to identify without domain expertise. In fact, it has been demonstrated that it's generally impossible to spot disparities when relying solely on proxies. Alternative approaches utilize pseudogroup formations through clustering, but the alignment of these artificially constructed groups with real protected groups highly varies with data distributions.

Distributionally robust optimization (DRO) and adversarially re-weighted learning (ARL) aim to achieve fair models without demographics and without proxy-based assumptions. DRO uses distributionally robust optimization to tackle worst case groups, while ARL concentrates on identifiable training errors through adversarially re-weighted learning strategy. Similar re-weighting strategies are seen in fair learning for supervised and self-supervised contexts. Although these max-min fairness-driven approaches have enhanced the underrepresented group's accuracy, they often fail in addressing societal biases from conventional group fairness perspectives and inadvertently amplify inherent biases, a phenomenon we observed in our experiments.

Non-limiting embodiments or aspects of the present disclosure may provide methods, systems, and/or computer program products that obtain a target data set including a plurality of first individuals, wherein each first individual is associated with a set of first non-protected features and a first binary class label; obtain a source dataset S including a plurality of second individuals, wherein each second individual is associated with a set of second non-protected features, a second binary class label, and a protected feature; jointly train a target encoder on the target data set and a source encoder on the source dataset; train a protected group estimator model on based an output of the source encoder; after jointly training the target encoder on the target data set T and the source encoder on the source dataset and training the protected group estimator model on the output of the source encoder, train the target encoder on the target data set and the protected group estimator model on an output of the target encoder; after training the target encoder and the protected group estimator model on the target data set: train a classifier model on the target data set; generate, with the target encoder and the protected group estimator model, based on the target data set, a plurality of protected features for the plurality of first individuals; train an adversarial network on an output of the classifier model; and for each first individual, debias the classifier model according to an objective function that depends on the output of the classifier associated with that individual, the first binary class label associated with that individual, the output of the adversarial network associated with that individual, and a protected feature of the plurality of protected features associated with that individual.

In this way, non-limiting embodiments or aspects of the present disclosure may provide methods, systems, and/or computer program products that leverage a shared latent space to approximate the inherent protected groups for fair learning. Despite the system not having direct access these protected groups, the unobserved groups are correlated with observed features x (e.g., zip codes often correlate with race, etc.) and outcomes y (e.g. disparities in outcomes often align with specific groups, etc.). While correlates of protected groups often trigger concerns in fairness literature, non-limiting embodiments or aspects of the present disclosure demonstrate how they can be beneficial for enhancing fairness metrics. Non-limiting embodiments or aspects of the present disclosure recognize that correlation of protected groups learned in a “source domain with demographics” (e.g., publicly available HMDA loan approval data includes demographics, etc.) can be effectively transferred to a “target domain without demographics” (e.g., a bank's internal data for credit card fraud detection where demographics have been excluded to preserve privacy, etc.). Non-limiting embodiments or aspects of the present disclosure further recognize that while both domains should have loose connection (e.g., both are financial domains in the running example, etc.), they might contain different individuals with varying observed features x and outcomes y (e.g., loan decisions in the source versus fraud detection in the target, etc.). Non-limiting embodiments or aspects of the present disclosure thus provide a fair learning algorithm for the target domain (e.g., a fair fraud detection system, etc.) via group estimates learned and adapted from the source domain.

Accordingly, non-limiting embodiments or aspects of the present disclosure learn to transform the data from source and target domain into correlated latent representations that encodes necessary information to jointly train a protected group estimator using source domain, while an adversarial debiasing method improves fairness in the downstream task on the target domain using the groups estimates, and adapt a noise injection-based unsupervised data augmentation technique to fine-tune the estimator on the target domain. For example, due to significant domain shifts and out-of-distribution examples, the group estimator's performance may degrade considerably on the target data. Non-limiting embodiments or aspects of the present disclosure address this by adopting a consistency training approach that refines group estimates on the target data by regularizing the estimator to be invariant to small noise injected to input examples. As an example, non-limiting embodiments or aspects of the present disclosure may use “source data with demographics” to ensure fairness in “target data without demographics” by first pre-training for estimating groups on shared representations between them, then fine-tuning for improving group estimates on target data, and finally debiasing the downstream model for target data with these estimates. While the SLSD model described herein operates without accessing protected attributes in the target data, non-limiting embodiments or aspects of the present disclosure also provide a relaxed variant, R-SLSD, which considers a very small subset (e.g., 1% of the training set) of the target data that provides protected attributes. Non-limiting embodiments or aspects of the present disclosure may thus improve fairness in the downstream task on the target domain using the groups estimates.

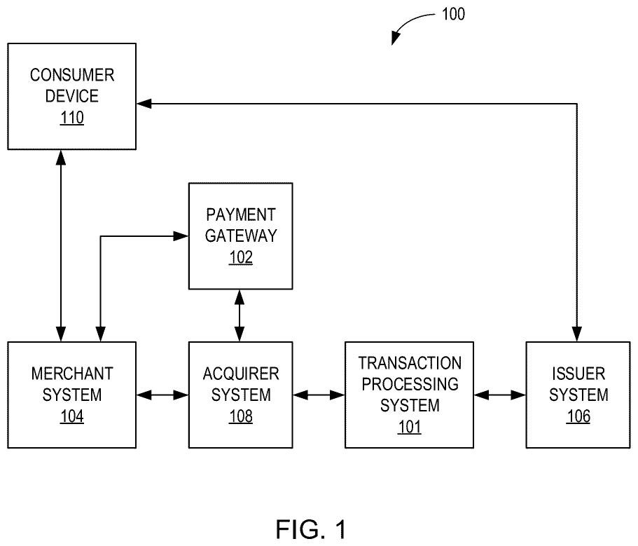

Referring now to FIG. 1, FIG. 1 shows an electronic payment processing network 100 according to non-limiting embodiments or aspects. The payment processing network may be used in conjunction with the systems and methods described herein. It will be appreciated that the particular arrangement of electronic payment processing network 100 shown is for example purposes only, and that various arrangements are possible. Transaction processing system 101 (e.g., a transaction handler) is shown to be in communication with one or more issuer systems (e.g., such as issuer system 106) and one or more acquirer systems (e.g., such as acquirer system 108). Although only a single issuer system 106 and single acquirer system 108 are shown, it will be appreciated that transaction processing system 101 may be in communication with a plurality of issuer systems and/or acquirer systems. In some embodiments, transaction processing system 101 may also operate as an issuer system such that both transaction processing system 101 and issuer system 106 are a single system and/or controlled by a single entity.

In some non-limiting embodiments or aspects, transaction processing system 101 may communicate with merchant system 104 directly through a public or private network connection. Additionally, or alternatively, transaction processing system 101 may communicate with merchant system 104 through payment gateway 102 and/or acquirer system 108. In some non-limiting embodiments or aspects, an acquirer system 1108 associated with merchant system 104 may operate as payment gateway 102 to facilitate the communication of transaction requests from merchant system 104 to transaction processing system 101. Merchant system 104 may communicate with payment gateway 102 through a public or private network connection. For example, a merchant system 104 that includes a physical POS device may communicate with payment gateway 102 through a public or private network to conduct card-present transactions. As another example, a merchant system 104 that includes a server (e.g., a web server) may communicate with payment gateway 102 through a public or private network, such as a public Internet connection, to conduct card-not-present transactions.

In some non-limiting embodiments or aspects, transaction processing system 101, after receiving a transaction request from merchant system 104 that identifies an account identifier of a payor (e.g., such as an account holder) associated with an issued payment device 110, may generate an authorization request message to be communicated to the issuer system 106 that issued the payment device 110 and/or account identifier. Issuer system 106 may then approve or decline the authorization request and, based on the approval or denial, generate an authorization response message that is communicated to transaction processing system 101. Transaction processing system 101 may communicate an approval or denial to merchant system 104. When issuer system 106 approves the authorization request message, it may then clear and settle the payment transaction between the issuer system 106 and acquirer system 108.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of system 100 may perform one or more functions described as being performed by another set of systems or another set of devices of system 100.

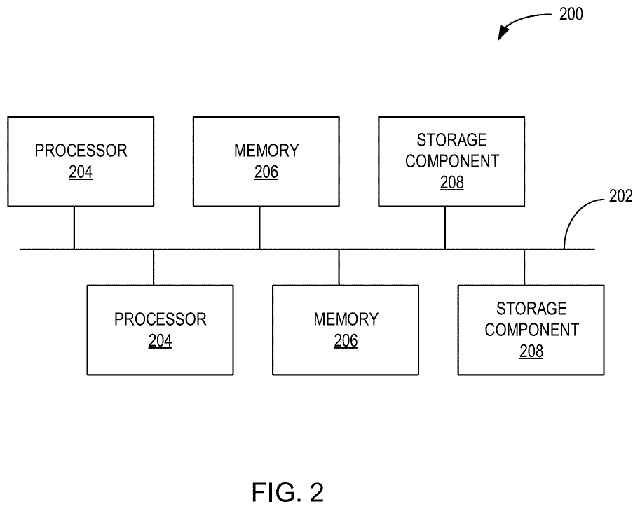

Referring now to FIG. 2, shown is a diagram of example components of a device 200 according to non-limiting embodiments. Device 200 may correspond to transaction processing system 101, payment gateway 102, merchant system 104, issuer system 106, acquirer system 108, and/or consumer device 110, as an example. In some non-limiting embodiments, such systems or devices may include at least one device 200 and/or at least one component of device 200. The number and arrangement of components shown are provided as an example. In some non-limiting embodiments, device 200 may include additional components, fewer components, different components, or differently arranged components than those shown. Additionally, or alternatively, a set of components (e.g., one or more components) of device 200 may perform one or more functions described as being performed by another set of components of device 200.

As shown in FIG. 2, device 200 may include a bus 202, a processor 204, memory 206, a storage component 208, an input component 210, an output component 212, and a communication interface 214. Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid-state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Non-limiting embodiments or aspects of the present disclosure provide a Shared Latent Space-based Debiasing (SLSD) approach and a relaxed modeling variant (R-SLSD) that may be structured in the following stages: 1) a pre-training phase, focusing on group estimations in the shared latent space, 2) a fine-tuning phase, which refines these estimations using consistency training, and 3) a debiasing phase, where rectifies biases in a downstream model with the refined group estimates.

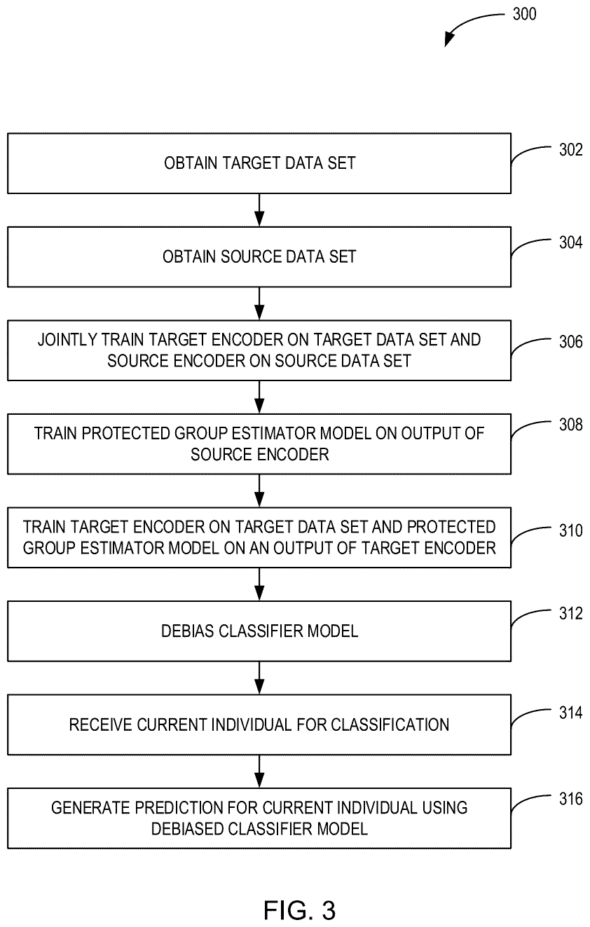

Referring now to FIG. 3, shown is a flow diagram for a method 300 for shared latent space-based debiasing, according to some non-limiting embodiments or aspects. The steps shown in FIG. 3 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 3, at step 302, method 300 includes obtaining a target data set. For example, transaction processing system 101 may obtain a target data set. As an example, transaction processing system 101 may obtain a target data set including a plurality of first individuals. Each first individual may be associated with a set of first non-protected features and a first binary class label.

Non-limiting embodiments or aspects of the present disclosure may consider a binary classification framework with tabular data, although non-limiting embodiments or aspects of the present disclosure can be generalized to other settings. For example given a target dataset [symbol] ={( [symbol] ) [symbol] consisting of [symbol] individuals, where [symbol] is an [symbol] dimensional input vector of non-protected features, and [symbol] represents its binary class label, assume that each individual in [symbol] belongs to an unobserved protected group [symbol] (e.g., men or women, etc.). For example, [symbol] may remain inaccessible both during training and inference.

As shown in FIG. 3, at step 304, method 300 includes obtaining a source data set. For example, transaction processing system 101 may obtain a source data set. As an example, transaction processing system 101 may obtain a source data set including a plurality of second individuals. Each second individual may be associated with a set of second non-protected features, a second binary class label, and a protected feature

Non-limiting embodiments or aspects of the present disclosure may consider a source dataset consisting of [symbol] individuals [symbol] ={ [symbol] [symbol] where again [symbol] is an [symbol] dimensional vector of non-protected features and [symbol] represents its binary class label. In contrast to the target dataset, the source dataset explicitly provides the protected groups [symbol] . The source and target datasets may differ significantly in terms of individuals and types of features, with potential disparities in sample sizes ( [symbol] ≠ [symbol] ), and feature dimensions ( [symbol] ≠ [symbol] ). For example, the plurality of first individuals may be different than plurality of second individuals, and/or the set of first non-protected features may be different than the set of second non-protected features.

Given this setup of target and source data sets, a goal of non-limiting embodiments or aspects of the present disclosure may be to leverage explicit groups [symbol] in [symbol] to estimate group memberships [symbol] for [symbol] . This inference serves as a foundation for developing a fair model M_{Θ}( [symbol] ), parameterized by Θ, for downstream tasks (e.g., fair lending decisions, etc.). Despite the absence of explicit [symbol] , non-limiting embodiments or aspects of the present disclosure may seek to lead M_{Θ}( [symbol] ) to be fair for a particular group, such as gender, and/or the like by selecting that group from [symbol] .

As shown in FIG. 3, at step 306, method 300 includes jointly training a target encoder on the target data set and a source encoder on the source data set. For example, transaction processing system 101 may jointly train a target encoder on the target data set and a source encoder on the source data set.

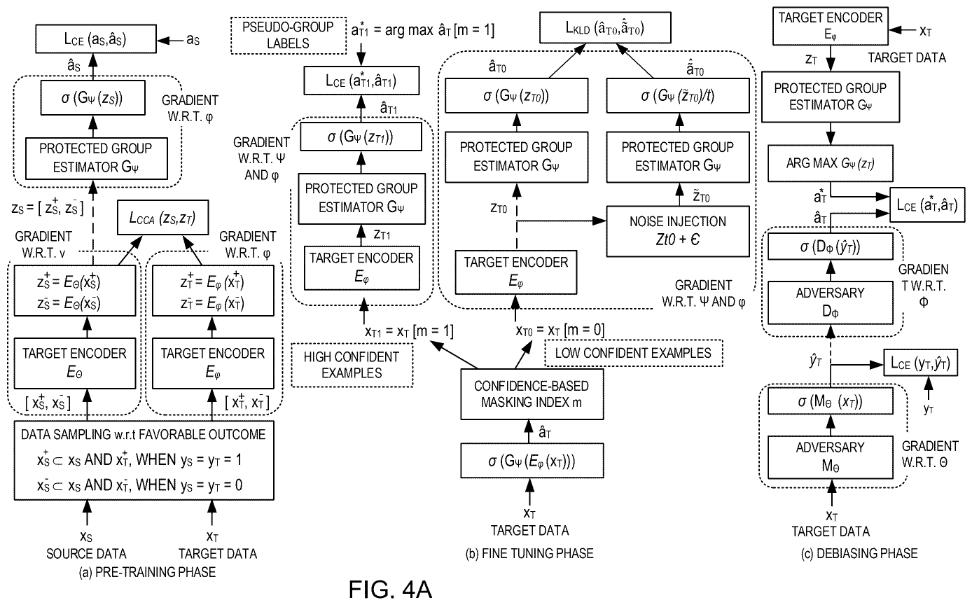

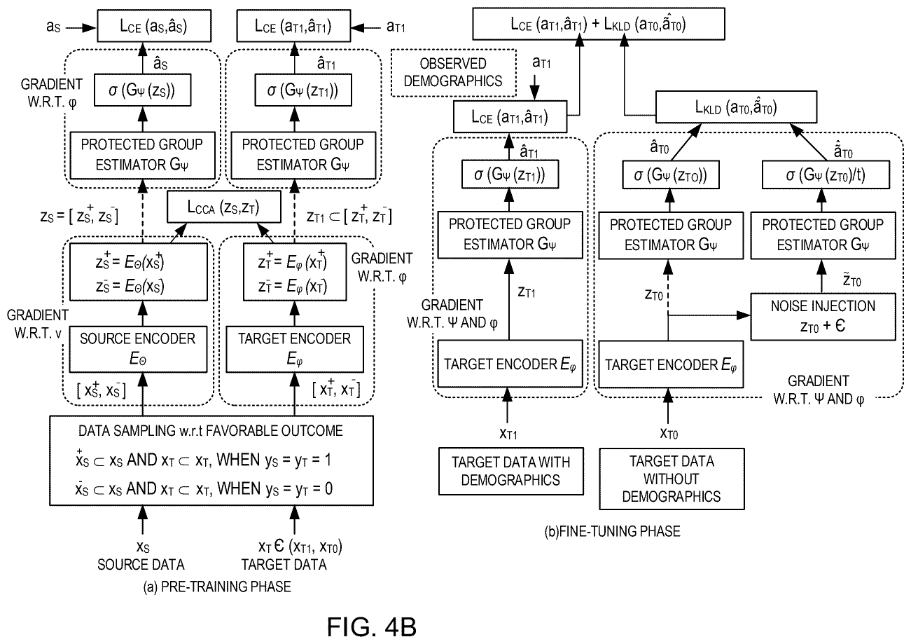

Referring also to FIG. 4A, which is a computational graph of a method for (SLSD), according to some non-limiting embodiments or aspects, a pre-training stage may learn complex nonlinear transformations between [symbol] and [symbol] such that the resulting representations [symbol] and [symbol] , respectively, are highly linearly correlated. Following Deep Canonical Correlation Analysis (CCA) as described by Andrew, Galen et al. in the paper entitled “Deep Canonical Correlation Analysis”, International Conference on Machine Learning (2013), the entire disclosure of which is hereby incorporated by reference in its entirety, non-limiting embodiments or aspects of the present disclosure can model both transformations with a source encoder E_{∂} as [symbol] =E_{∂}( [symbol] ) and a target encoder E_{φ} as [symbol] =E_{φ}( [symbol] ), where the corresponding parameters ∂ and φ are jointly learned to maximize the total correlation between [symbol] and [symbol] . However, Deep CCA was originally designed to find linear relationships between two views of the same dataset (e.g., correlating images with their textual descriptions, etc.). Applying this approach directly to the distinct datasets [symbol] and [symbol] , each with its own unique individuals and features may not be meaningful due to the lack of inherent linkage between them.

To address this, non-limiting embodiments or aspects of the present disclosure provide a straightforward data sampling technique that establishes an indirect relationship between [symbol] and [symbol] . For example, transaction processing system 101 may jointly train the target encoder on the target data set and the source encoder on the source dataset by: sampling, from the target data set, a first subset of the first individuals associated with the first binary class label including a positive and a second subset of the first individuals associated with the first binary class label including a negative; sampling, from the source data set, a first subset of the second individuals associated with the second binary class label including a positive and a second subset of the second individuals associate with the second binary class label including a negative; and simultaneously encoding (i) instances of the set of first non-protected features associated with the first subset of the first individuals with the target encoder and (ii) instances of the set of second non-protected features and the protected feature associated with the first subset of the second individuals with the source encoder; and simultaneously encoding (a) instances of the set of first non-protected features associated with the second subset of the first individuals with the target encoder and (b) instances of the set of second non-protected features and the protected feature associated with the second subset of the second individuals with the source encoder.

As an example, outcomes may typically vary from favorable or positive outcomes, such as loan approvals to unfavorable or negative outcomes, like loan rejections. Positive subsets [symbol] ⊂ [symbol] and [symbol] ⊂ [symbol] of [symbol] and [symbol] individuals may be denoted, respectively, when [symbol] = [symbol] =1. The negative counterparts [symbol] and [symbol] may consist of the remaining [symbol] and [symbol] individuals. The data sampling technique according to non-limiting embodiments or aspects ensures that positive instances from both datasets are concurrently transformed by their respective encoders a [symbol] =E_{∂}( [symbol] )s and [symbol] =E_{φ}( [symbol] ), and similarly for the negative instances. Furthermore, non-limiting embodiments or aspects of the present disclosure may adjust the sampling rate for [symbol] and [symbol] , by either oversampling or downsampling, to ensure [symbol] = [symbol] and [symbol] = [symbol] . This balancing act enables jointly training the target encoder on the target data set and the source encoder on the source dataset to include effective optimization of the CCA loss in terms of the covariance and variance according to the following Equation (1):

$${ℒ}_{CCA} ( {z}_{𝒮} , {z}_{𝒯} ) = - {\sum }_{i = 1}^{{n}_{𝒮}^{+}} cov ( {z}_{𝒮}^{+ ( i )} , {z}_{𝒯}^{+ ( i )} ) / \sqrt{var ( {z}_{𝒮}^{+ ( i )} ) var ( {z}_{𝒯}^{+ ( i )} )} - {\sum }_{i = 1}^{{n}_{𝒮}^{-}} cov ( {z}_{𝒮}^{- ( i )} , {z}_{𝒯}^{- ( i )} ) / \sqrt{var ( {z}_{𝒮}^{- ( i )} ) var ( {z}_{𝒯}^{- ( i )} )} \qquad ( 1 )$$

For example, [symbol] may be an output of the source encoder generated on an instance of the set of second non-protected features and the protected feature associated with the first subset of the second individual, [symbol] may be an output of the target encoder generated based on an instance of the set of first non-protected features associated with the first subset of the first individuals, [symbol] may be an output of the source encoder generated based on an instance of the set of second non-protected features and the protected feature associated with the second subset of the second individuals, [symbol] may be an output of the target encoder generated based on an instance of the set of first non-protected features associated with the second subset of the first individuals, [symbol] may be a second individual of the first subset of the second individuals, and [symbol] may be a second individual of the second subset of the second individuals.

Minimizing the L_{CCA}( [symbol] ) is equivalent to maximizing according to the following Equation (2):

$${max}_{ϑ , φ} Tr ( {z}_{𝒮}^{T} , {z}_{𝒯} ) s . t . {z}_{𝒮}^{T} {z}_{𝒮} = {z}_{𝒯}^{T} {z}_{𝒯} = I , \qquad ( 2 )$$

where [symbol] =[ [symbol] ] and [symbol] =[ [symbol] ] are the corresponding concatenations. The representations [symbol] and [symbol] may serve a dual purpose: the representations [symbol] and [symbol] may be discriminative enough for group estimations, and simultaneously, invariant to discrepancies between source and target domains. To fulfill this, non-limiting embodiments or aspects of the present disclosure provide a “cross-domain” Protected Group Estimator (PGE) model G_{Ψ} that takes encoded representations as input to estimate group memberships. Each of E_{φ} and G_{Ψ} may be shared across all three training phases but may not be used during the inference of downstream fair model.

As shown in FIG. 3, at step 308, method 300 includes training a protected group estimator model on an output of the source encoder. For example, transaction processing system 101 may train a protected group estimator model on an output of the source encoder. As an example, and referring again to FIG. 4A, in the pre-training phase, G_{Ψ} may aim to minimize a cross entropy (CE) loss, using only the observed [symbol] according to the following Equation (3):

$${ℒ}_{CE} ( {\hat{a}}_{𝒮} , {a}_{𝒮} ) = - {\sum }_{i = 1}^{{n}_{S}} {\sum }_{k = 1}^{K} {a}_{𝒮 , k}^{( i )} log ( {\hat{a}}_{𝒮 , k}^{( i )} ) \qquad ( 3 )$$

where [symbol] =σ(G_{Ψ}( [symbol] ) is the Softmax output of G_{ψ}, with [symbol] as its input. For example, [symbol] may be the protected feature associated with a current instance associated with a current second individual [symbol] , [symbol] may be the output of the protected group estimator model for the current instance associated with the current second individual [symbol] , K may a number of groups in a domain of the source dataset, and Therefore, a final pre-training objective may be defined according to the following Equation (4):

$${min}_{ϑ , φ , Ψ} {ℒ}_{CCA} ( {z}_{𝒮} , {z}_{𝒯} ) + {ℒ}_{CE} ( {\hat{a}}_{𝒮} , {a}_{𝒮} ) \qquad ( 4 )$$

As shown in FIG. 3, at step 310, method 300 includes training the target encoder on the target data set and the protected group estimator model on an output of the target encoder. For example, transaction processing system 101 may train the target encoder on the target data set and the protected group estimator model on an output of the target encoder. As an example, after jointly training the target encoder on the target data set and the source encoder on the source dataset and training the protected group estimator model on the output of the source encoder, transaction processing system 101 may train the target encoder on the target data set and the protected group estimator model on an output of the target encoder

Referring again to FIG. 4A, non-limiting embodiments or aspects of the present disclosure may use a fine-tuning focused on enhancing each of the target encoder E_{φ} and PGE G_{Ψ} for the target data, given the restrictions of unobserved [symbol] , which is inspired by the semi-supervised learning method described by Xie et al. in the paper entitled “Unsupervised data augmentation for consistency training” in Advances in Neural Information Processing Systems, 33: 6256-6268 (2020), the entire disclosure of which is hereby incorporated by reference in its entirety, which uses data augmentation for consistency training. However, the method of Xie et al. relies on a small set of labeled data to optimize the supervised CE loss, while concurrently optimizing the unsupervised consistency loss for the larger unlabeled set. Additionally, noising operations for data augmentation of Xie et al., specifically designed for image and text data, are not suitable for a tabular data context. To tackle these challenges, non-limiting embodiments or aspects of the present disclosure extend the method of Xie et al. by optimizing supervised CE loss with entirely unsupervised data and incorporating an effective noise injection mechanism on E_{φ}'s encoded representations for consistency training.

As the protected group estimator G_{Ψ} may be pre-trained solely on [symbol] , non-limiting embodiments or aspects may start by masking out those samples in the target data for which G_{Ψ} displays low confidence regarding the estimated group probabilities [symbol] =σ(G_{Ψ}( [symbol] )), where [symbol] =E_{φ}( [symbol] ). For example, non-limiting embodiments or aspects may define a masking index m. For the top half, [symbol] /2, of individuals with the highest probabilities across estimated group categories, the masking index may be set as m=1 to extract the corresponding samples as [symbol] = [symbol] [m=1]. For the remaining samples, the masking index may be set as m=0 to designate the remaining samples as [symbol] = [symbol] [m=0]. For the supervised portion of training, group probabilities may be estimated as [symbol] =σ(G_{Ψ}(E_{φ}( [symbol] ))), where [symbol] is a first group of the first individuals extracted by a mask, and [symbol] is a second group of the first individuals remaining after the mask. Using these high-confidence samples, non-limiting embodiments or aspects of the present disclosure may generate pseudo-group labels as [symbol] =arg [symbol] and plug the pseudo-group labels in Equation (3).

In the unsupervised consistency training, various noise injections into [symbol] =E_{φ}( [symbol] ), ranging from Gaussian to drop-out and Laplace noises were explored. Based on observations, small random perturbations, particularly jittering drawn from a Cauchy distribution with heavier tails, proved to be the most effective noise mechanism. A noising operation according to non-limiting embodiments or aspects may be formulated as [symbol] = [symbol] +∈, where ∈˜Cauchy (μ, γ), and μ=0 and γ=200 may be set for each experiment. The consistency loss may be computed as a Kullback-Leibler (KL) divergence between the estimated group probabilities according to the following Equation (5):

$${ℒ}_{KLD} ( {\hat{\tilde{a}}}_{𝒯0} , {\hat{a}}_{𝒯0} ) = {\hat{a}}_{𝒯0} \cdot ( log {\hat{a}}_{𝒯0} - log {\hat{\tilde{a}}}_{𝒯0} ) \qquad ( 5 )$$

where [symbol] =σ(G_{Ψ}( [symbol] )) and [symbol] =σ(G_{Ψ}( [symbol] /t)), using a reduced Softmax temperature or function t. Given that prior studies emphasize the advantages of reducing prediction entropy in noisy scenarios, non-limiting embodiments or aspects of the present disclosure may sharpen group predictions on augmented representations by setting t to 0.4. A final fine-tuning objective may be defined according to the following Equation (6):

$${min}_{φ , Ψ} {ℒ}_{CE} ( {\hat{a}}_{𝒯1} , {a}_{𝒯1}^{*} ) + {ℒ}_{KLD} ( {\hat{\tilde{a}}}_{𝒯0} , {\hat{a}}_{𝒯0} ) \qquad ( 6 )$$

For example, [symbol] a may be an output generated by the target encoder and the protected group estimator model based on the first group of the first individuals extracted by a mask [symbol] , [symbol] may be a pseudo group label, [symbol] may be an output generated by the target encoder and the protected group estimator model based on the second group of the first individuals remaining after the mask [symbol] , [symbol] may be an output generated by the target encoder and the protected group estimator model based on the second group of the first individuals remaining after the mask [symbol] that has been injected with noise.

A fine-tuning procedure according to non-limiting embodiments or aspects, by minimizing each of CE loss with pseudo group assignments and divergence with noise injection, may gradually propagates the high confident group assignments from [symbol] to low confident [symbol] .

Referring now to FIG. 4B, FIG. 4B is a computational graph of a method for relaxed-shared latent space debiasing (R-SLSD), according to some non-limiting embodiments or aspects. A relaxed modeling variant according to non-limiting embodiments or aspects, which may be referred to herein as “R-SLSD”, assumes that only a small fraction of the target data provides access to protected attributes. For example, using the previous notation: [symbol] ⊂ [symbol] may now represent a small subset with observed [symbol] , while [symbol] ⊂ [symbol] may represent the larger subset where [symbol] remains unobserved. To utilize the [symbol] while pre-training encoders and PGE models in R-SLSD, Equation (4) can be extended by incorporating [symbol] =σ(G_{Ψ}(E_{φ}( [symbol] ))) according to the following Equation (7):

$${min}_{ϑ , φ , Ψ} {ℒ}_{CCA} ( {z}_{𝒮} , {z}_{𝒯} ) + {ℒ}_{CE} ( {\hat{a}}_{𝒮} , {a}_{𝒮} ) + {L}_{CE} ( {\hat{a}}_{𝒯1} , {a}_{𝒯1} ) \qquad ( 7 )$$

Under an R-SLSD framework according to non-limiting embodiments or aspects, generating pseudo-group labels via confidence-based masking during the fine-tuning phase may no longer be necessary. Therefore, the pseudo-groups [symbol] in Equation (6) can be replaced with observed [symbol] according to the following Equation (8):

$${min}_{φ , Ψ} {ℒ}_{CE} ( {\hat{a}}_{𝒯1} , {a}_{𝒯1} ) + {ℒ}_{KLD} ( {\hat{\tilde{a}}}_{𝒯0} , {\hat{a}}_{𝒯0} ) , \qquad ( 8 )$$

where the consistency training for [symbol] with unobserved [symbol] proceeds in the same manner as the SLSD approach according to non-limiting embodiments or aspects.

As shown in FIG. 3, at step 312, method 300 includes debiasing a classifier model. For example, transaction processing system 101 may debias a classifier model by training the classifier model on the target data set; generating, with the target encoder and the protected group estimator model, based on the target data set, a plurality of protected features for the plurality of first individuals; training an adversarial network on an output of the classifier model; and for each first individual, debiasing the classifier model according to an objective function that depends on the output of the classifier associated with that individual, the first binary class label associated with that individual, the output of the adversarial network associated with that individual, and a protected feature of the plurality of protected features associated with that individual. As an example, after training the target encoder and the protected group estimator model on the target data set, transaction processing system 101 may debias a classifier model by training the classifier model on the target data set; generating, with the target encoder and the protected group estimator model, based on the target data set, a plurality of protected features for the plurality of first individuals; training an adversarial network on an output of the classifier model; and for each first individual, debiasing the classifier model according to an objective function that depends on the output of the classifier associated with that individual, the first binary class label associated with that individual, the output of the adversarial network associated with that individual, and a protected feature of the plurality of protected features associated with that individual.

A debiasing approach according to non-limiting embodiments or aspects may follow the same or similar procedures for each of the SLSD and R-SLSD approaches according to non-limiting embodiments or aspects. In an ideal scenario where the protected group estimations are perfect (e.g., if G_{Ψ} estimates the groups with absolute accuracy, etc.), non-limiting embodiments or aspects may readily apply any existing fairness algorithm to debias the downstream ML model, simply by replacing the true protected groups with the estimates. While achieving a perfect G_{Ψ} is infeasible, fair learning methods, which rely on explicit measurements of fairness metric to compute constraints or penalties, struggle to effectively debias the downstream model when paired with non-limiting embodiments or aspects. This is presumably due to the high sensitivity of the fairness metric to the noisy group estimates, leading the model to converge in a bad solution.

To solve this problem, non-limiting embodiments or aspects of the present disclosure extend an adversarial debiasing method as described by Louppe et al. in the paper entitled “Learning to pivot with adversarial networks” in Advances in Neural Information Processing Systems, 30 (2017), the entire disclosure of which is hereby incorporated by reference in its entirety, to make the downstream model's predictions independent of G_{Ψ}'s estimations, eliminating the need for explicit fairness metric measurement during training. Suppose M_{Θ} is the downstream classifier model which takes [symbol] as input and predicts the outcome [symbol] for each individual, who belongs to the unknown protected group [symbol] . Given the fine-tuned encoder E_{φ} and PGE G_{Ψ}, the group assignments can be estimated according to the following Equation (9):

$${a}_{𝒯}^{*} = arg max {G}_{Ψ} ( {E}_{φ} ( {x}_{𝒯} ) ) \qquad ( 9 )$$

An adversarial network D_{φ} may be designed that receives classifier's predictions [symbol] =σ(M_{Θ}( [symbol] )), as input and attempts to predict groups as [symbol] =σ(D_{φ}( [symbol] )). The learning objective to debias M_{Θ} may a min-max problem according to the following Equation (10):

$${min}_{Θ} {max}_{Φ} {ℒ}_{CE} ( {\hat{y}}_{𝒯} , {y}_{𝒯} ) - {λℒ}_{CE} ( {\hat{a}}_{𝒯} , {a}_{𝒯}^{*} ) \qquad ( 10 )$$

For example, [symbol] may be the output of the classifier, [symbol] may be is the first binary class label for a first individual, [symbol] may be an output of the adversarial model, [symbol] may be a generated protected feature for a first individual, and λ may be a hyperparameter, where λ>0 trades between classifier M_{Θ}'s utility and fairness. Larger λ allows to achieve more fairness, but with greater loss in predictive performance, while smaller λ has the opposite impact. In this debiasing procedure, the adversary D_{φ}, penalizes the classifier M_{Θ}if the PGE G_{Ψ}'s output is predictable from the M_{Θ}'s output. For example, D_{φ} may aim to assure that predictions from M_{Θ} are independent of the estimated group assignments [symbol] .

Referring again to FIGS. 4A and 4B, target encoder and a group estimator may be shared across each phase. Standard feed-forward networks may be used implement each of SLSD and R-SLSD according to non-limiting embodiments or aspects. An architecture for source encoder E_{∂}, target encoder E_{φ}, classifier M_{Θ} and adversary D_{φ} may include fully connected three-layer feed-forward networks (e.g., 256-128-64, etc.) with ReLU activations. Although the PGE G_{Ψ} can be a deep network, a linear structure without hidden layers may be used in some implementations, for example, for small academic benchmark datasets, where necessary features for group estimations are already extracted by the encoders. Notably, for adversarial debiasing, a warm start initialization procedure may be used before optimizing the min-max problem in Equation (10). The training for the debiasing may be summarized in the following steps: 1) pre-training M_{Θ} for the entire data, 2) pre-training D_{φ}, on the M_{Θ}'s predictions, and 3) alternately training M_{Θ} and D_{φ} for each mini-batch by first training D_{φ}, while keeping M_{Θ} fixed and then training M_{Θ} while keeping D_{φ} fixed.

After debiasing the classifier model, transaction processing system 101 may provide the debiased classifier model. For example, transaction processing system 101 may store the debiased classifier model in a data structure or memory.

As shown in FIG. 3, at step 314, method 300 includes receiving a current data set including at least one current individual. For example, transaction processing system 101 may receive a current data set including at least one current individual. As an example, the at least one current individual may be associated with at least one current set of non-protected features. In such an example, the at least one current set of non-protected features may include the same or similar features as the target dataset. For example, the at least one current set of non-protected features may include features associated with fraud detection, loan decisions, and/or the like.

As shown in FIG. 3, at step 314, method 300 includes generating, using the debiased classifier model, based on the at least one current set of non-protected features, at least one current prediction for the at least one current individual. For example, transaction processing system 101 may generate, using the debiased classifier model, based on the at least one current set of non-protected features, at least one current prediction for the at least one current individual. As an example, transaction processing system 101 may provide, as input to the debiased classifier model, the at least one current set of non-protected features and, receive as output from the debiased classifier model, at least one prediction or classification for the at least one current individual. In such an example, transaction processing system 101 may automatically authorize or deny, based on the at least one prediction or classification for the at least one current individual, at least one target action associated with the at least one individual (e.g., automatically authorize or deny at least one target action in electronic payment processing network 100, etc.)

In some non-limiting embodiments or aspects, the at least one prediction or classification for the at least one current individual may include at least one loan approval or loan rejection. For example, transaction processing system 101 may automatically approve an electronic loan request or automatically reject an electronic loan request based on the at least one prediction or classification for the at least one current individual.

In some non-limiting embodiments or aspects, the at least one prediction or classification for the at least one current individual may include at least one prediction of fraud associated with an electronic payment transaction associated with the at least one current individual (e.g., a fraud prediction, a no fraud prediction, a likelihood or probability of fraud, etc.). For example, transaction processing system 101 may automatically approve the electronic payment transaction or automatically reject the electronic payment transaction based on the at least one prediction or classification for the at least one current individual.

### Example Experiments

A comprehensive evaluation of SLSD and R-SLSD according to non-limiting embodiments or aspects was conducted on three benchmark datasets [detailed dataset's descriptions are in the Supplementary Appendix]: 1) Adult: income prediction, 2) ACSIncome: another variant of income prediction, and 3) Default: credit card default prediction. For each dataset, gender (e.g., men and women, etc.) is selected as the protected attribute. Additionally, a case study was conducted on the COMPAS dataset, which has faced criticism for racial bias in criminal recidivism predictions, focusing on the protected attribute race (e.g., white and black, etc.).

To assess predictive accuracy, the area under the ROC curve (AUC) and balanced accuracy (Bal. Acc.) are measured, averaged over all (overall) instances, given their robustness against class imbalance. For fairness evaluation, well-recognized group fairness metrics demographic parity difference (DPD) and demographic parity ratio (DPR) are used, which quantify disparities in favorable outcomes between privileged (e.g. men, etc.) and unprivileged (e.g., women, etc.) groups. In line with DRO and ARL, AUC (min) and Bal. Acc. (min) metrics are also reported, which denote the minimum AUC and Bal. Acc. values across all protected groups. These metrics serve as representations of Rawlsian max-min fairness. A lower DPD is desirable, while for other metrics, higher values are preferable. The protected features are used for fairness evaluation on the test subset of the target dataset.

An experimental methodology may be designed for a transfer learning between source and target datasets. Specifically, ACSIncome serves as the source when Adult is the target, and conversely, Adult becomes the default source for other target datasets. While SLSD operates fully unsupervised in terms of protected features in the target, the R-SLSD randomly incorporates these features for 1% of training examples.

A same experimental setup, architecture, and hyper-parameter tuning is used for each of the approaches reported in the experimental section. Each dataset is randomly split into 70% training and 30% test sets. Hyper-parameter tuning, including learning rate, mini-batch size, and the fairness tuning parameter A (from Equation (10)), is conducted on the training set. Best hyper-parameter values for each approach are chosen via grid-search by performing 5-fold cross-validation optimizing for the best overall balanced accuracy. Note that protected features are not used for tuning. Once the hyper-parameters are tuned, the independent test set is used for unbiased performance assessment. All experimental results are averaged across 10 independent runs, with different model parameter initialization.

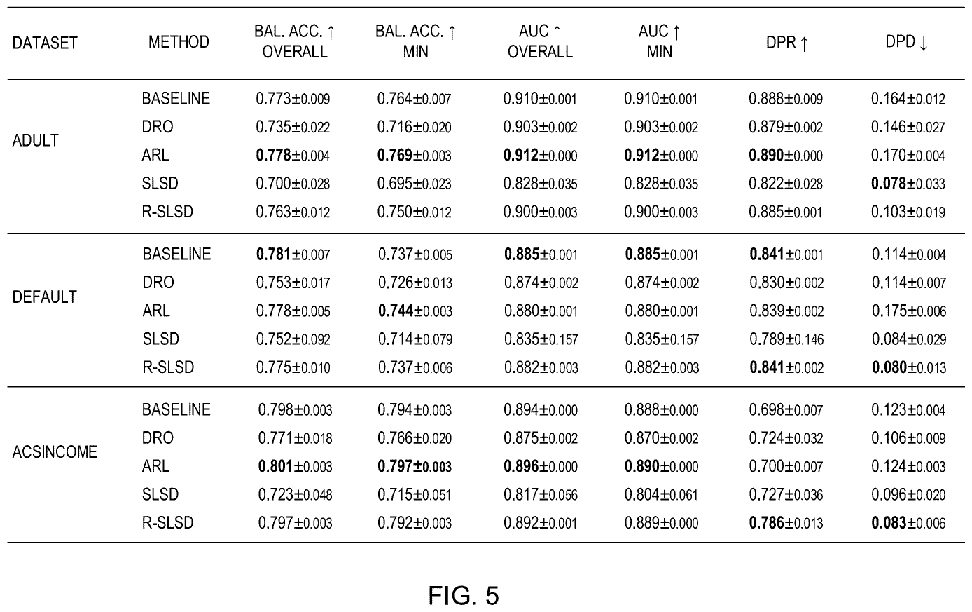

Main comparisons are with DRO, a group-agnostic distributionally robust optimization, and ARL, a group-agnostic adversarially reweighted learning technique. Results for the standard group-agnostic Baseline classifier are also reported, which emphasizes solely accurate predictions, without any fairness considerations. FIG. 5 is a table including average performance metrics for example experiments with standard deviations across runs, with best results highlighted in bold. The following observations are made.

Each of SLSD and R-SLSD according to non-limiting embodiments or aspects improve group fairness. SLSD and R-SLSD according to non-limiting embodiments or aspects outperform other models in group fairness metrics across all datasets. Specifically, SLSD is the fairest model for the Adult in terms of both DPR and DPD, while R-SLSD leads in fairness improvement for the Default and ACSIncome datasets. When compared to the Baseline model on these datasets, SLSD notably improves DPR by 64.8%, 13.7%, and 4.2% and DPD by 52.4%, 26.3%, and 22.0%, while R-SLSD improves DPR by 60.2%, 14.8%, and 12.6% and DPD by 37.2%, 29.8%, and 32.5%, respectively.

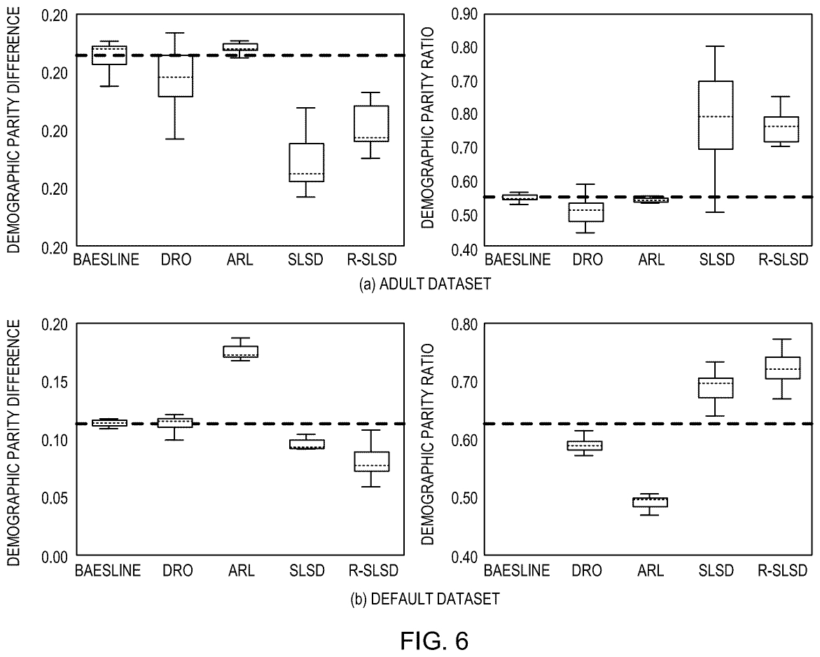

DRO and ARL often amplify existing biases. While the intent of any fair learning algorithm is to address biases present in the standard Baseline model, both DRO and ARL often underperform or can even intensify these biases. FIG. 6 is graphs of group fairness metrics for example experiments. FIG. 6 shows DPD and DPR for all methods over 10 runs with varied model initializations. For both Adult and Default datasets, DRO and ARL amplify the Baseline model's biases. In contrast, SLSD and R-SLSD models according to non-limiting embodiments or aspects consistently mitigate these biases.

Cost of utility in SLSD: Pursuing improved group fairness often results in a compromise on predictive accuracy, a well-established trade-off. Given SLSD's dual challenges of improving fairness and bridging domain shifts between source and target, it unsurprisingly sacrifices both AUC and balanced accuracy. As DRO and ARL primarily aim to enhance utility metrics for under-performing groups, easily outperform SLSD in these measures. However, an R-SLSD model according to non-limiting embodiments or aspects offers a promising balance, even overtaking DRO in utility.

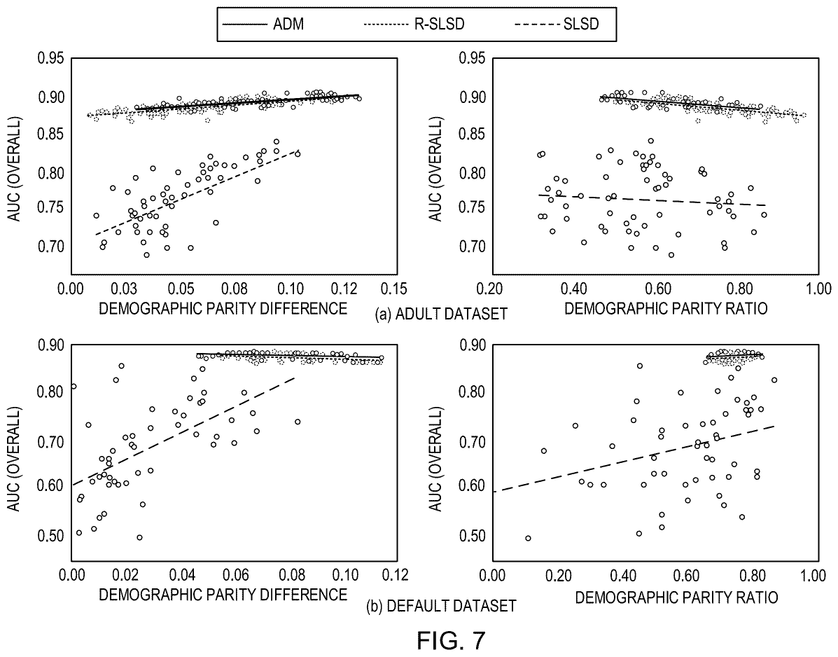

To highlight advantages of SLSD and R-SLSD models according to non-limiting embodiments or aspects, SLSD and R-SLSD models according to non-limiting embodiments or aspects are compared with the original adversarial debiasing model (ADM), which demands access to protected features for all training instances. FIG. 7 is graphs comparing cross-validation grid search analysis of example experiments for SLSD and R-SLSD models according to non-limiting embodiments or aspects and the ADM on the Adult and Default datasets. As shown in FIG. 7, SLSD according to non-limiting embodiments or aspects outperforms in both DPD and DPR metrics without any protected target data, at the expense of AUC. Using just 1% of protected data, R-SLSD according to non-limiting embodiments or aspects closely mirrors ADM's performance, which utilizes 100% of protected data, in both utility and fairness.

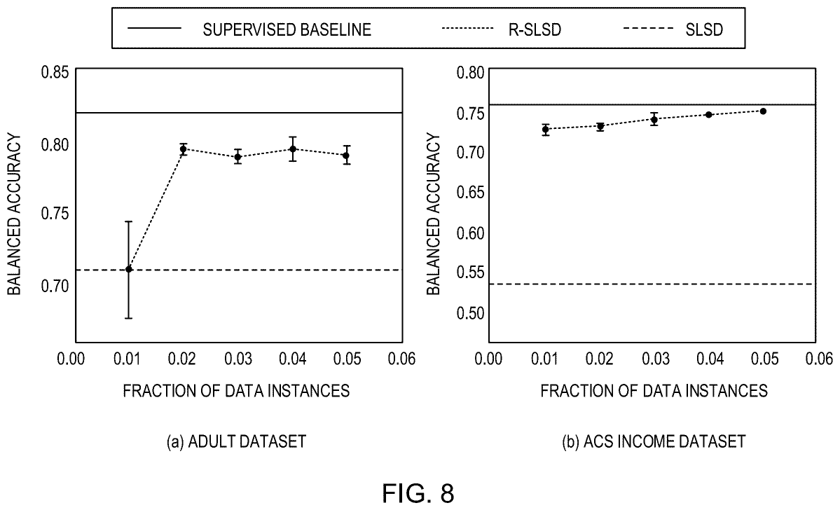

A debiasing method according to non-limiting embodiments or aspects may depend on the group estimations. FIG. 8 is graphs showing protected group estimation of example experiments comparing SLSD and R-SLSD models according to non-limiting embodiments or aspects with a fully supervised model. A fully supervised classifier is trained to predict groups and established as a benchmark. This Supervised Baseline consistently outperforms SLSD in balanced accuracy for group estimations. As expected, when the data fraction of group labels available to R-SLSD increases, its performance approximates the Supervised Baseline.

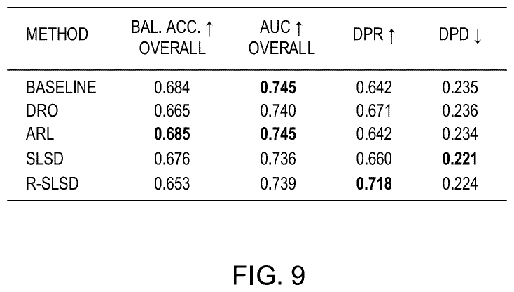

In an extreme example experimental scenario, where the COMPAS criminal recidivism is the target dataset for all models, SLSD and R-SLSD models according to non-limiting embodiments or aspects use the Adult income prediction as the source dataset. FIG. 9 is a table including average performance metrics for an extreme experimental scenario. As shown in FIG. 9, given completely distinct domains (e.g., financial vs criminal justice, etc.), a fairness improvement of SLSD and R-SLSD models SLSD and R-SLSD models according to non-limiting embodiments or aspects sharply decreases, compared to earlier experiments. This anticipated decline is presumably due to the significant domain shift, complicating the alignment between the source and target domains. However, SLSD and R-SLSD according to non-limiting embodiments or aspects still surpass DRO and ARL in DPD. Regarding DPR, R-SLSD outperforms both DRO and ARL, though DRO edges out SLSD.

In a further comparison, results for a standard group agnostic Baseline classifier are provided. This Baseline model prioritizes accurate predictions, without any fairness considerations. In a separate experiment, SLSD and R-SLSD models according to non-limiting embodiments or aspects are compared with the original ADM. This is a fully supervised fair model, requiring access to protected features across all training samples. Findings remain consistent across these evaluations and can be summarized into the following points.

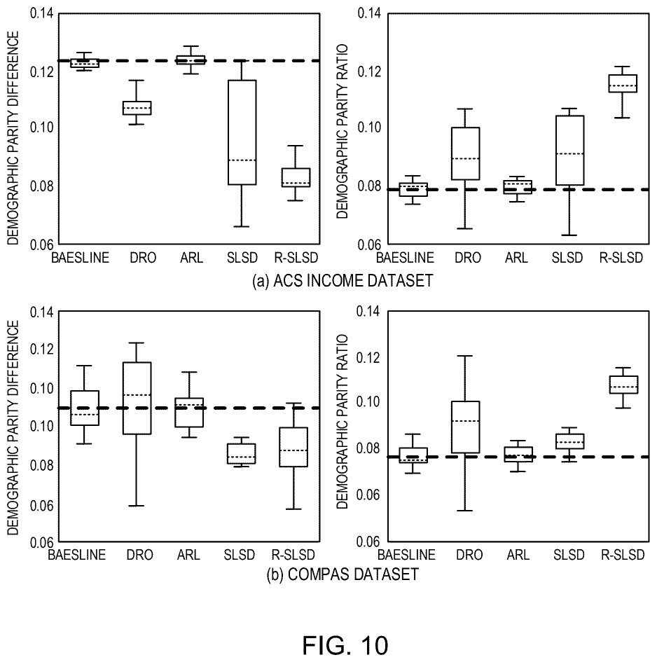

The bias amplification of DRO and ARL. FIG. 10 is graphs of fairness metrics for additional example experiments. FIG. 10 shows DPD and DPR for all methods over 10 experimental runs with different model initializations on the remaining ACSIncome and COMPAS datasets. Observations for the ACSIncome and COMPAS datasets aligns with what observations for the Adult and Default datasets previously discussed: each of DRO and ARL often underperform or can even intensify the existing biases of the standard Baseline model. In contrast, SLSD and R-SLSD models according to non-limiting embodiments or aspects consistently mitigate these biases, even when SLSD and R-SLSD are trained for the extreme scenario study with the COMPAS dataset.

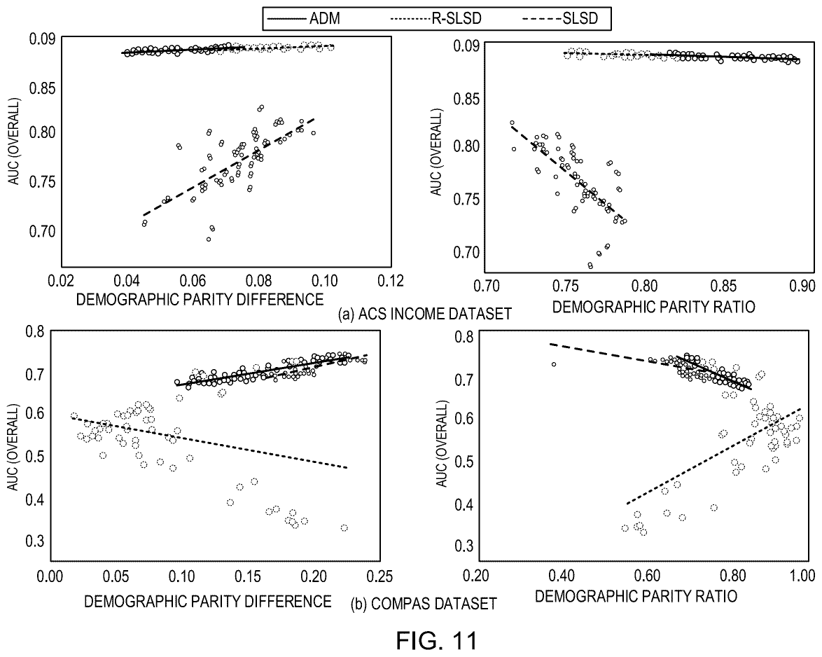

Grid search analysis with supervised ADM. FIG. 11 is graphs comparing cross-validation grid search analysis of additional example experiments for SLSD and R-SLSD models according to non-limiting embodiments or aspects and an ADM. FIG. 11 presents the cross-validation grid search analysis for SLSD, R-SLSD, and ADM on each of the ACSIncome and COMPAS datasets. For ACSIncome, using just 1% of the protected data, R-SLSD's performance closely aligns with that of ADM, which utilizes 100% of the protected data, in both utility and fairness. Particularly, most R-SLSD models demonstrate better fairness in terms of both DPD and DPR compared to the majority of ADM models with a roughly equivalent AUC. Surprisingly, for the COMPAS dataset, a role reversal is observed in performance: R-SLSD outperforms both ADM and SLSD in fairness metrics with a greater sacrifice in AUC, while SLSD's performance is approximately similar to ADM's performance.

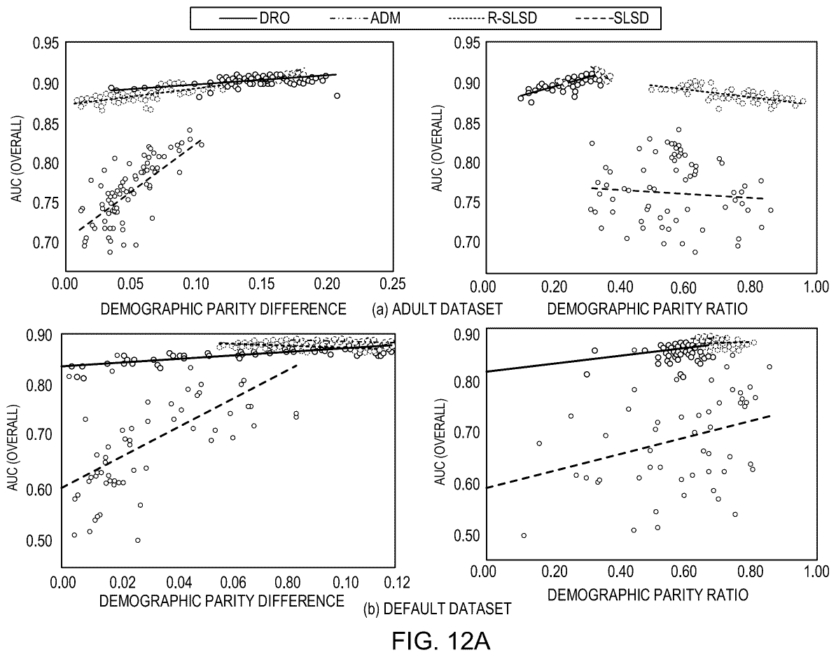

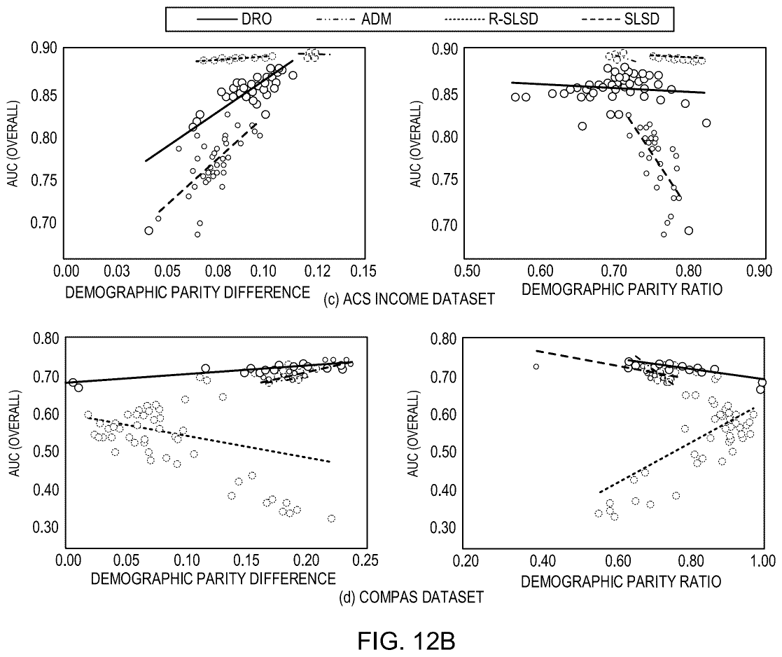

Grid search analysis with DRO and ARL. FIGS. 12A and 12B are graphs comparing cross-validation grid search analysis of additional example experiments for SLSD and R-SLSD models according to non-limiting embodiments or aspects and DRO and ARL. For all datasets, except COMPAS, SLSD outperforms other models in both DPD and DPR metrics, however, with a greater loss in AUC. Conversely, R-SLSD consistently shows a balance between fairness and utility. Specifically, R-SLSD performs similarly to the best predictive model, ARL, in terms of AUC, yet R-SLSD significantly surpasses ARL in fairness metrics—DPD and DPR. Interestingly, the results for the COMPAS dataset show an opposite trend between SLSD and R-SLSD compared to other datasets. However, these results may be attributed on the COMPAS dataset to the extreme scenario study, and viewed as outliers.

SLSD and R-SLSD according to non-limiting embodiments or aspects are compared with two naive baselines and two state-of-the-art approaches. All methods have the same DNN architecture, optimizer, and activation functions. Below are the implementation details:

Baseline: This baseline classifier is a straightforward vanilla model with a standard binary cross-entropy loss. It focuses solely on accurate predictions, disregarding any fairness considerations. The classifier's architecture consists of a fully connected three-layer feed-forward network with dimensions 256-128-64 and uses ReLU activations. All subsequent fairness modeling approaches aim to debias this classifier.

ADM: This model is the original adversarial debiasing model as proposed by Zhang et al. in the paper entitled “Mitigating unwanted biases with adversarial learning” in Proceedings of the AAAI/ACM Conference on AI, Ethics, and Society, 335-340 (2018), the entire disclosure of which is hereby incorporated by reference in its entirety. It requires access to protected features for every training instance. In this approach, an adversarial network penalizes the classifier if the true protected attributes can be predicted from the classifier's predicted output. The adversarial network's architecture uses the Baseline classifier's architecture, consisting of a fully connected three-layer feed-forward network with dimensions 256-128-64 and using ReLU activations. Like SLSD and R-SLSD, the ADM also has a fairness tuning hyper-parameter, A, which balances the prediction loss and fairness.

DRO: This is a distributionally robust learning approach for fair classification without demographics as described by Hashimoto et al. in the paper entitled “Fairness without demographics in repeated loss minimization” in International Conference on Machine Learning, 1929-1938 PMLR (2018), the entire disclosure of which is hereby incorporated by reference in its entirety. DRO also has a fairness tuning hyper-parameter rn that controls the performance for the worst-case subgroup.

ARL: This is an adversarially reweighted learning approach for fair classification without demographics as described by Lahoti et al. in the paper entitled “Fairness without demographics through adversarially reweighted learning” in Advances in Neural Information Processing Systems, 33: 728-740 (2020), the entire disclosure of which is hereby incorporated by reference in its entirety. Although the classifier is designed with the same deep network architecture as the aforementioned Baseline classier, a linear adversary network is used to reweight the binary cross-entropy loss. Note that ARL does not have any additional fairness trade-off hyperparameter.

Each dataset is randomly split into a 70% training set and a 30% test set. All models are trained using adaptive gradient descent optimization (Adam) in PyTorch, with 1 epoch for the largest dataset, ACSIncome, and 10 epochs for the other datasets. The best hyper-parameter values are determined for all approaches on the training set through a grid-search strategy. Once the hyper-parameters are tuned, an independent test set is used for an unbiased performance assessment. All experimental results are averaged across 10 independent runs, each with a different random initialization of model parameters. This experimental setup, data splitting method, and parameter tuning technique are consistently applied to all methods.

For each approach, the optimal learning rate and batch size is identified by performing a grid search over an exhaustive hyper-parameter space. This space is defined by learning rates of {0.0001, 0.0005, 0.001, 0.005, 0.01, 0.05}, and batch sizes of {64, 128, 256, 512}. The fairness tuning parameter A for ADM, SLSD, and R-SLSD is grid-searched over values of {1.0, 2.0, 3.0, 4.0}. Given that the scale of the fairness tuning parameter η for DRO differs from λ, its grid search is conducted over values of {0.3, 0.4, 0.5, 0.6, 0.7, 0.8}. Additionally, both SLSD and R-SLSD have another hyper-parameter for the dimension of shared latent vectors. A grid search for this latent size is conducted over values of {32,64}. All parameters are chosen using 5-fold crossvalidation, optimizing for the best-balanced accuracy.

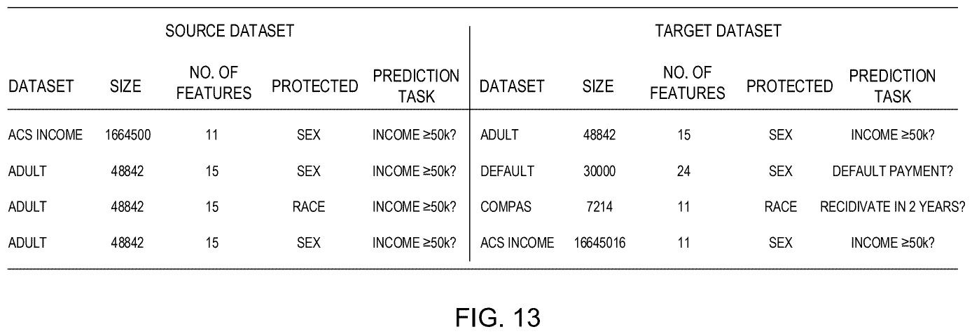

FIG. 13 is a table showing a summary of datasets for example experiments.

The Adult dataset is the UCI Adult dataset which contains US census income survey records from the 1994 U.S. census. The binarized “income” feature is utilized as the outcome variable for classification tasks, aiming to predict whether an individual's income exceeds 50 k dollars.

The ACSIncome data set serves as an enhanced alternative to the well-known UCI Adult dataset. ACSIncome presents several advantages, such as offering a larger number of data points (1,664,500 compared to 48,842) and more contemporary data (sourced from 2018 as opposed to 1994). The ACSIncome dataset gathered data from the American Community Survey (ACS) of the Public Use Microdata Sample (PUMS). It's noteworthy that this originates from a different source than the Annual Social and Economic Supplement (ASEC) of the Current Population Survey (CPS), which was used to construct the original UCI Adult dataset. Additionally, the ACSIncome dataset is filtered, ensuring ACSIncome only encompasses individuals over 16 years old who worked a minimum of 1 hour per week in the preceding year and had earnings of at least 100 dollars. For this dataset, similar to the approach with the UCI Adult dataset, the “income” feature is binarized to predict if an individual's income exceeds 50 k dollars.

The Default dataset provides a study of customers' default payments in Taiwan, collected in 2005. For classification tasks, the binary outcome variable indicating whether a customer would “default” on their payment next month (Yes=1, No=0) is used.

Ernst and Young (EY) conducted a case study examining unfairness in credit models, and addressed gender disparities in financial lending decisions. In this analysis, Microsoft and EY showcased how to identify and rectify unfairness in the loan lending process. Since the dataset for this case study is not publicly available, the Microsoft Fairlearn team presented an example wherein a semi-synthetic feature is introduced into the publicly available UCI Default dataset, aiming to replicate the outcome disparity observed in EY's original study.

Following the Fairlearn example, example experiments described herein incorporated a synthetic “Interest” feature into the dataset, creating a correlation between the “sex” of an applicant and the default outcome. The “Interest” feature can be conceptualized as the interest rate assigned to an applicant. An applicant with a history of defaulting on credit card payments would likely be offered a loan at a higher interest rate. Given the historical context wherein banks predominantly lent to men, there's a reduced rate of uncertainty for these applicants. Hence, the “Interest” feature is derived from a Gaussian distribution based on the following criteria: if sex=male, draw Interest ˜(4·Default, 2), and if sex=female, draw Interest ˜(4·Default, 4).

The COMPAS dataset regarding a system that is used to predict criminal recidivism, which has been criticized for potential racial bias. The ground truth of recidivism, which indicates whether an offender was re-arrested within a two-year period, serves as the outcome variable for classification tasks.

Non-limiting embodiments or aspects of the present disclosure may address potential privacy concerns related to group estimates by adopting federated learning, which may involve training the debiasing network on encrypted group estimates from SLSD in a secure environment. Once the downstream model is adjusted for fairness, the redundant debiasing components can be discarded during inference, eliminating residual privacy risks. Non-limiting embodiments or aspects of the present disclosure may be expanded to a multi-dimensional protected groups setting, which may use more than a one-vs-all approach due to potential computational inefficiency and loss from data-sparsity issue of intersecting groups. To tackle this, non-limiting embodiments or aspects of the present disclosure may use learning multidimensional representations where each dimension corresponds to a protected group. Furthermore, SLSD according to non-limiting embodiments or aspects may be extended to multi-class classification and regression tasks by directly utilizing a debiasing approach according to non-limiting embodiments or aspects, where the adversary takes the classifier's predicted probabilities or the regression model's continuous outcome. This, however, introduces complexity for data sampling in the pre-training phase, as information on individuals with both favorable and unfavorable outcomes is used to map the disadvantaged groups in the latent space. Non-limiting embodiments or aspects of the present disclosure may binarize the output space for these tasks. Non-limiting embodiments or aspects of the present disclosure may offer flexibility in replacing the debiasing phase with other techniques, such as fair representation learning, by providing group estimates instead of the true protected groups.

The journey towards algorithmic fairness is deeply embedded within broader social and historical discourses on equity and justice. Existing solutions for fairness without demographics mainly focus on addressing representation bias. However, fairness is not just a technical problem, it also encompasses societal, philosophical, and legal dimensions. Non-limiting embodiments or aspects of the present disclosure provide a promising direction of domain adaptation while acknowledging the complexities of demographic-agnostic fairness. SLSD according to non-limiting embodiments or aspects, with its wide applicability in fairness-aware applications, particularly in industries where demographic data collection is legally restricted, mitigates current privacy concerns in the ML fairness.

### Pseudocodes

As previously described herein, an SLSD model according to non-limiting embodiments or aspects, which may function without direct access to the protected attributes from the target dataset, is illustrated in FIG. 4A. A relaxed variant, an R-SLSD model according to non-limiting embodiments or aspects, which may use a small subset of such data, is illustrated in FIG. 4B.

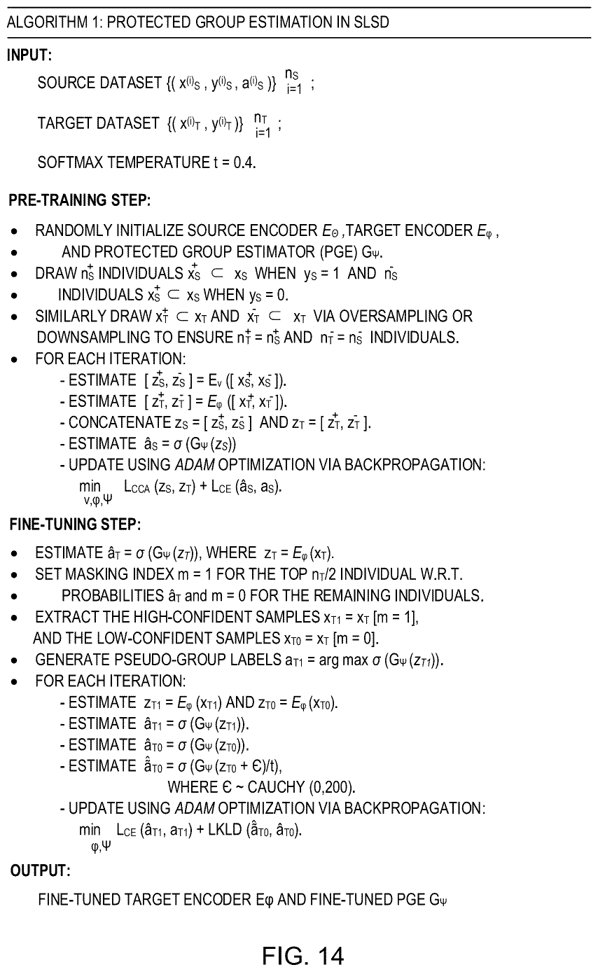

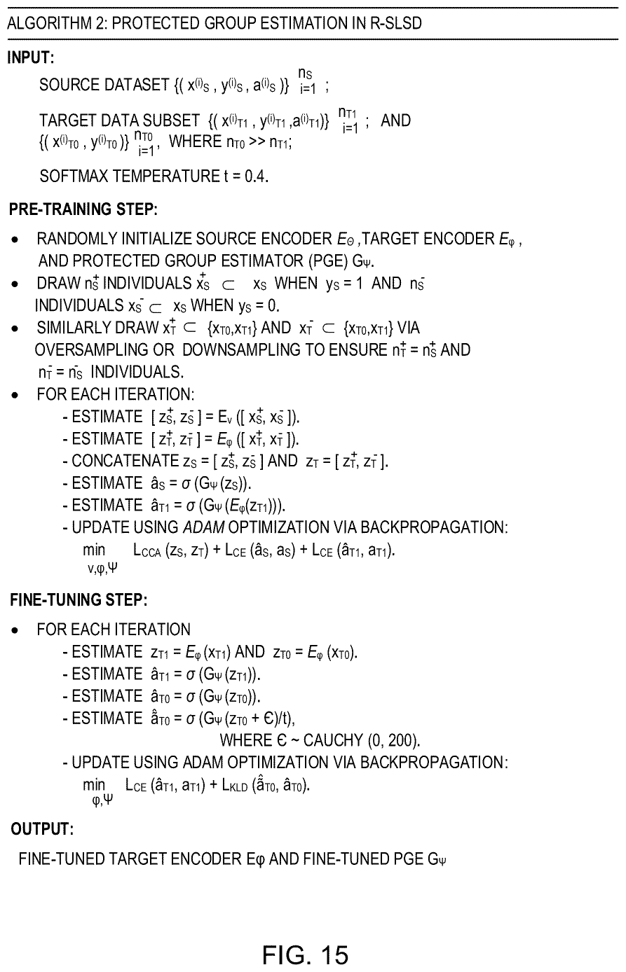

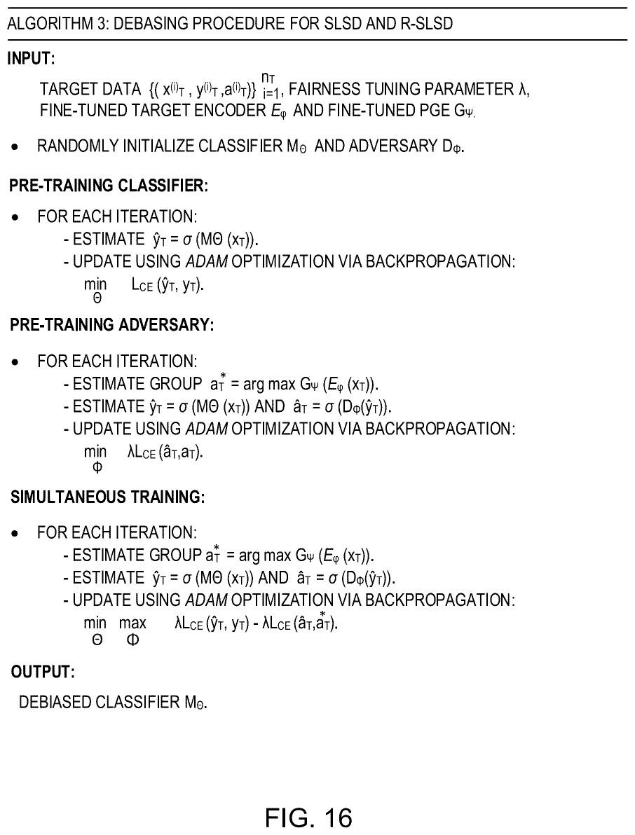

A training process for each of SLSD and R-SLSD according to non-limiting embodiments or aspects involves an estimation of protected attributes for a given target dataset. To provide clarity and further illustrate SLSD and R-SLSD models according to non-limiting embodiments or aspects, pseudocodes are provided in FIGS. 14-16, in which FIG. 14 includes pseudocode for protected group estimations in SLSD, FIG. 15 includes pseudocode for protected group estimation in R-SLSD, and, given that the debiasing steps for each of SLSD and R-SLSD are identical, FIG. 16 includes pseudocode for debiasing of a downstream model in SLSD and R-SLSD.

Aspects described include artificial intelligence or other operations whereby the system processes inputs and generates outputs with apparent intelligence. The artificial intelligence may be implemented in whole or in part by a model. A model may be implemented as a machine learning model. The learning may be supervised, unsupervised, reinforced, or a hybrid learning whereby multiple learning techniques are employed to generate the model. The learning may be performed as part of training. Training the model may include obtaining a set of training data and adjusting characteristics of the model to obtain a desired model output. For example, three characteristics may be associated with a desired item location. In such instance, the training may include receiving the three characteristics as inputs to the model and adjusting the characteristics of the model such that for each set of three characteristics, the output device state matches the desired device state associated with the historical data.

In some implementations, the training may be dynamic. For example, the system may update the model using a set of events. The detectable properties from the events may be used to adjust the model.

The model may be an equation, artificial neural network, recurrent neural network, convolutional neural network, decision tree, or other machine-readable artificial intelligence structure. The characteristics of the structure available for adjusting during training may vary based on the model selected. For example, if a neural network is the selected model, characteristics may include input elements, network layers, node density, node activation thresholds, weights between nodes, input or output value weights, or the like. If the model is implemented as an equation (e.g., regression), the characteristics may include weights for the input parameters, thresholds, or limits for evaluating an output value, or criterion for selecting from a set of equations.

Once a model is trained, retraining may be included to refine or update the model to reflect additional data or specific operational conditions. The retraining may be based on one or more signals detected by a device described herein or as part of a method described herein. Upon detection of the designated signals, the system may activate a training process to adjust the model as described.

Further examples of machine learning and modeling features which may be included in the embodiments discussed above are described in “A survey of machine learning for big data processing” by Qiu et al. in EURASIP Journal on Advances in Signal Processing (2016) which is hereby incorporated by reference in its entirety.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A method, comprising:
obtaining, with at least one processor, a target data set including a plurality of first individuals, wherein each first individual is associated with a set of first non-protected features and a first binary class label;
obtaining, with the at least one processor, a source dataset including a plurality of second individuals, wherein each second individual is associated with a set of second non-protected features, a second binary class label, and a protected feature;
jointly training, with the at least one processor, a target encoder on the target data set and a source encoder on the source data set;
training, with the at least one processor, a protected group estimator model on an output of the source encoder;
after jointly training the target encoder on the target data set and the source encoder on the source dataset and training the protected group estimator model on the output of the source encoder, training, with the at least one processor, the target encoder on the target data set and the protected group estimator model on an output of the target encoder;
after training the target encoder and the protected group estimator model on the target data set, debiasing, with the at least one processor, a classifier model by:
training the classifier model on the target data set;
generating, with the target encoder and the protected group estimator model, based on the target data set, a plurality of protected features for the plurality of first individuals;
training an adversarial network on an output of the classifier model; and
for each first individual, debiasing the classifier model according to an objective function that depends on the output of the classifier associated with that first individual, the first binary class label associated with that first individual, the output of the adversarial network associated with that first individual, and a protected feature of the plurality of protected features associated with that first individual.

2. The method of claim 1, wherein the plurality of first individuals is different than plurality of second individuals, and wherein the set of first non-protected features is different than the set of second non-protected features.

3. The method of claim 1, wherein jointly training, with the at least one processor, the target encoder on the target data set and the source encoder on the source dataset includes:
sampling, from the target data set, a first subset of the first individuals associated with the first binary class label including a positive and a second subset of the first individuals associated with the first binary class label including a negative;
sampling, from the source data set, a first subset of the second individuals associated with the second binary class label including a positive and a second subset of the second individuals associate with the second binary class label including a negative;
simultaneously encoding (i) instances of the set of first non-protected features associated with the first subset of the first individuals with the target encoder and (ii) instances of the set of second non-protected features and the protected feature associated with the first subset of the second individuals with the source encoder; and
simultaneously encoding (a) instances of the set of first non-protected features associated with the second subset of the first individuals with the target encoder and (b) instances of the set of second non-protected features and the protected feature associated with the second subset of the second individuals with the source encoder.

4. The method of claim 3, wherein jointly training, with the at least one processor, the target encoder on the target data set and the source encoder on the source dataset includes optimizing a canonical correlation loss L_{CCA} loss according to the following Equation:
$${ℒ}_{CCA} ( {z}_{𝒮} , {z}_{𝒯} ) = - {\sum }_{i = 1}^{{n}_{𝒮}^{+}} cov ( {z}_{𝒮}^{+ ( i )} , {z}_{𝒯}^{+ ( i )} ) / \sqrt{var ( {z}_{𝒮}^{+ ( i )} ) var ( {z}_{𝒯}^{+ ( i )} )} - {\sum }_{i = 1}^{{n}_{𝒮}^{-}} cov ( {z}_{𝒮}^{- ( i )} , {z}_{𝒯}^{- ( i )} ) / \sqrt{var ( {z}_{𝒮}^{- ( i )} ) var ( {z}_{𝒯}^{- ( i )} )}$$
where E_{∂} is the source encoder, [symbol] is an output of the source encoder as [symbol] =E_{∂}( [symbol] ) for an instance of non-protected features [symbol] , E_{φ} is the target encoder, [symbol] is an output of the target encoder as [symbol] =E_{φ}( [symbol] ) for an instance of protected features [symbol] ⊂ [symbol] and [symbol] ⊂ [symbol] are positive subsets of [symbol] and [symbol] of first and second individuals, respectively, [symbol] and [symbol] are negative counterparts of the positive subsets, [symbol] =E_{∂}( [symbol] ) is positive instance of non-protected features transformed by the source encoder, [symbol] =E_{φ}( [symbol] ) is a positive instance of protected features transformed by the target encoder, [symbol] =E_{∂}( [symbol] ) is a negative instance of non-protected features transformed by the source encoder, [symbol] =E_{φ}( [symbol] ) is a negative instance of protected features transformed by the target encoder, wherein minimizing the canonical correlation loss L_{CCA} is equivalent to maximizing according to the following Equation:
$${max}_{ϑ , φ} Tr ( {z}_{𝒮}^{T} , {z}_{𝒯} ) s . t . {z}_{𝒮}^{T} {z}_{𝒮} = {z}_{𝒯}^{T} {z}_{𝒯} = I ,$$
where [symbol] =[ [symbol] ] and [symbol] =[ [symbol] ] are corresponding concatenations.

5. The method of claim 4, wherein training, with the at least one processor, the protected group estimator model on based the output of the source encoder includes minimizing a cross-entropy loss L_{CE} according to the following Equation:
$${ℒ}_{CE} ( {\hat{a}}_{𝒮} , {a}_{𝒮} ) = - {\sum }_{i = 1}^{{n}_{𝒮}} {\sum }_{k = 1}^{K} {a}_{𝒮 , k}^{( i )} log ( {\hat{a}}_{𝒮 , k}^{( i )} )$$
where G_{Ψ} is the protected group estimator model, [symbol] =σ(G_{Ψ}( [symbol] )) is a softmax output of the protected group estimator model for an output of the source encoder as [symbol] for the instance of non-protected features [symbol] with a protected group [symbol] , and K is a number of groups in a domain of the source dataset, such that minimizing the canonical correlation loss L_{CCA} is further defined according to the following equation:
$${min}_{ϑ , φ , Ψ} {ℒ}_{CCA} ( {z}_{𝒮} , {z}_{𝒯} ) + {ℒ}_{CE} ( {\hat{a}}_{𝒮} , {a}_{𝒮} ) .$$

6. The method of claim 5, wherein training, with the at least one processor, the target encoder on the target data set and the protected group estimator model on the output of the target encoder includes:
computing a consistency loss as a Kullback-Leibler (KL) divergence according to the following Equation:
$${ℒ}_{KLD} ( {\hat{\tilde{a}}}_{𝒯0} , {\hat{a}}_{𝒯0} ) = {\hat{a}}_{T 0} \cdot ( log {\hat{a}}_{𝒯0} - log {\hat{\tilde{a}}}_{𝒯0} )$$
where [symbol] =σ(G_{Ψ}( [symbol] )), [symbol] =σ(G_{Ψ}( [symbol] /t)), t is a softmax temperature or function; and
minimizing a cross-entropy loss L_{CE} according to the following Equation:
$${min}_{φ , Ψ} {ℒ}_{CE} ( {\hat{a}}_{𝒯1} , {a}_{𝒯1}^{*} ) + {ℒ}_{KLD} ( {\hat{\tilde{a}}}_{𝒯0} , {\hat{a}}_{𝒯0} )$$
where [symbol] =σ(G_{Ψ}( [symbol] )), m is a masking index, [symbol] /2 is a top half of first individuals with highest probabilities across estimated group categories for which the masking index is set as m=1 to extract corresponding samples as [symbol] = [symbol] [m=1], [symbol] = [symbol] [m=0] is the remaining samples for which the masking index is set as m=0, [symbol] =(G_{Ψ}(E_{φ}( [symbol] ))), where [symbol] is a first group of the first individuals extracted by a mask, and [symbol] is a second group of the first individuals remaining after the mask, and pseudo-group labels are generated as [symbol] =arg [symbol] .

7. The method of claim 6, wherein a learning objective for debiasing the classifier model is a min-max problem defined according to the following Equation:
$${min}_{Θ} {max}_{Φ} {ℒ}_{CE} ( {\hat{y}}_{𝒯} , {y}_{𝒯} ) - {λℒ}_{CE} ( {\hat{a}}_{𝒯} , {a}_{𝒯}^{*} )$$
where M_{Θ}is the classifier model which takes [symbol] as input and predicts an outcome [symbol] for each first individual, who belongs to the unknown protected group [symbol] , λ is a hyperparameter, and D_{φ}is the adversarial network that receives the classifier's predictions [symbol] =σ(M_{Θ}( [symbol] )) as input predict groups as [symbol] =α(D_{φ}( [symbol] )), and wherein group assignments can be estimated according to the following Equation:
$${a}_{𝒯}^{*} = arg max {G}_{Ψ} ( {E}_{φ} ( {x}_{𝒯} ) ) .$$

8. A system, comprising:
at least one processor configured to:
obtain a target data set including a plurality of first individuals, wherein each first individual is associated with a set of first non-protected features and a first binary class label;
obtain a source dataset including a plurality of second individuals, wherein each second individual is associated with a set of second non-protected features, a second binary class label, and a protected feature;
jointly train a target encoder on the target data set and a source encoder on the source data set;
train a protected group estimator model on an output of the source encoder;
after jointly training the target encoder on the target data set and the source encoder on the source dataset and training the protected group estimator model on the output of the source encoder, train the target encoder on the target data set and the protected group estimator model on an output of the target encoder;
after training the target encoder and the protected group estimator model on the target data set, debias a classifier model by:
training the classifier model on the target data set;
generating, with the target encoder and the protected group estimator model, based on the target data set, a plurality of protected features for the plurality of first individuals;
training an adversarial network on an output of the classifier model; and
for each first individual, debiasing the classifier model according to an objective function that depends on the output of the classifier associated with that first individual, the first binary class label associated with that first individual, the output of the adversarial network associated with that first individual, and a protected feature of the plurality of protected features associated with that first individual.

9. The system of claim 8, wherein the plurality of first individuals is different than plurality of second individuals, and wherein the set of first non-protected features is different than the set of second non-protected features.

10. The system of claim 8, wherein the at least one processor is configured to jointly train the target encoder on the target data set and the source encoder on the source dataset by:
sampling, from the target data set, a first subset of the first individuals associated with the first binary class label including a positive and a second subset of the first individuals associated with the first binary class label including a negative;
sampling, from the source data set, a first subset of the second individuals associated with the second binary class label including a positive and a second subset of the second individuals associate with the second binary class label including a negative;
simultaneously encoding (i) instances of the set of first non-protected features associated with the first subset of the first individuals with the target encoder and (ii) instances of the set of second non-protected features and the protected feature associated with the first subset of the second individuals with the source encoder; and
simultaneously encoding (a) instances of the set of first non-protected features associated with the second subset of the first individuals with the target encoder and (b) instances of the set of second non-protected features and the protected feature associated with the second subset of the second individuals with the source encoder.

11. The system of claim 10, wherein the at least one processor is configured to jointly train the target encoder on the target data set and the source encoder on the source dataset by optimizing a canonical correlation loss L_{CCA} loss according to the following Equation:
$${ℒ}_{CCA} ( {z}_{𝒮} , {z}_{𝒯} ) = - {\sum }_{i = 1}^{{n}_{𝒮}^{+}} cov ( {z}_{𝒮}^{+ ( i )} , {z}_{𝒯}^{+ ( i )} ) / \sqrt{var ( {z}_{𝒮}^{+ ( i )} ) var ( {z}_{𝒯}^{+ ( i )} )} - {\sum }_{i = 1}^{{n}_{𝒮}^{-}} cov ( {z}_{𝒮}^{- ( i )} , {z}_{𝒯}^{- ( i )} ) / \sqrt{var ( {z}_{𝒮}^{- ( i )} ) var ( {z}_{𝒯}^{- ( i )} )}$$
where E_{∂} is the source encoder, [symbol] is an output of the source encoder as [symbol] =E_{∂}( [symbol] ) for an instance of non-protected features [symbol] , E_{φ} is the target encoder, [symbol] is an output of the target encoder as [symbol] =E_{φ}( [symbol] ) for an instance of protected features [symbol] ⊂ [symbol] and [symbol] ⊂ [symbol] are positive subsets of [symbol] and [symbol] of first and second individuals, respectively, [symbol] and [symbol] are negative counterparts of the positive subsets, [symbol] =E_{∂}( [symbol] ) is positive instance of non-protected features transformed by the source encoder, [symbol] =E_{φ}( [symbol] ) is a positive instance of protected features transformed by the target encoder, [symbol] =E_{∂}( [symbol] ) is a negative instance of non-protected features transformed by the source encoder, [symbol] =E_{φ}( [symbol] ) is a negative instance of protected features transformed by the target encoder, wherein minimizing the canonical correlation loss L_{CCA} is equivalent to maximizing according to the following Equation:
$${max}_{ϑ , φ} Tr ( {z}_{𝒮}^{T} , {z}_{𝒯} ) s . t . {z}_{𝒮}^{T} {z}_{𝒮} = {z}_{𝒯}^{T} {z}_{𝒯} = I ,$$
where [symbol] =[ [symbol] ] and [symbol] =[ [symbol] ] are corresponding concatenations.

12. The system of claim 11, wherein the at least one processor is configured to train the protected group estimator model on based the output of the source encoder by minimizing a cross-entropy loss L_{CE} according to the following Equation:
$${ℒ}_{CE} ( {\hat{a}}_{𝒮} , {a}_{𝒮} ) = - {\sum }_{i = 1}^{{n}_{𝒮}} {\sum }_{k = 1}^{K} {a}_{𝒮 , k}^{( i )} log ( {\hat{a}}_{𝒮 , k}^{( i )} )$$
where G_{Ψ} is the protected group estimator model, [symbol] =σ(G_{Ψ}( [symbol] )) is a softmax output of the protected group estimator model for an output of the source encoder as [symbol] for the instance of non-protected features [symbol] with a protected group [symbol] , and K is a number of groups in a domain of the source dataset, such that minimizing the canonical correlation loss L_{CCA} is further defined according to the following equation:
$${min}_{ϑ , φ , Ψ} {ℒ}_{CCA} ( {z}_{𝒮} , {z}_{𝒯} ) + {ℒ}_{CE} ( {\hat{a}}_{𝒮} , {a}_{𝒮} ) .$$

13. The system of claim 12, wherein the at least one processor is configured to train the target encoder on the target data set and the protected group estimator model on the output of the target encoder by:
computing a consistency loss as a Kullback-Leibler (KL) divergence according to the following Equation:
$${ℒ}_{KLD} ( {\hat{\tilde{a}}}_{𝒯0} , {\hat{a}}_{𝒯0} ) = {\hat{a}}_{𝒯0} \cdot ( log {\hat{a}}_{𝒯0} - log {\hat{\tilde{a}}}_{𝒯0} )$$
where [symbol] =σ(G_{Ψ}( [symbol] )), [symbol] =σ(G_{Ψ}( [symbol] /t)), t is a softmax temperature or function; and
minimizing a cross-entropy loss L_{CE} according to the following Equation:
$${min}_{φ , Ψ} {ℒ}_{CE} ( {\hat{a}}_{𝒯1} , {a}_{𝒯1}^{*} ) + {ℒ}_{KLD} ( {\hat{\tilde{a}}}_{𝒯0} , {\hat{a}}_{𝒯0} )$$
where [symbol] =σ(G_{Ψ}( [symbol] )), m is a masking index, [symbol] /2 is a top half of first individuals with highest probabilities across estimated group categories for which the masking index is set as m=1 to extract corresponding samples as [symbol] = [symbol] [m=1], [symbol] = [symbol] [m=0] is the remaining samples for which the masking index is set as m=0, [symbol] =σ(G_{Ψ}(E_{φ}( [symbol] ))), where [symbol] is a first group of the first individuals extracted by a mask, and [symbol] is a second group of the first individuals remaining after the mask, and pseudo-group labels are generated as [symbol] =arg [symbol] .

14. The system of claim 13, wherein a learning objective for debiasing the classifier model is a min-max problem defined according to the following Equation:
$${min}_{Θ} {max}_{Φ} {ℒ}_{CE} ( {\hat{y}}_{𝒯} , {y}_{𝒯} ) - {λℒ}_{CE} ( {\hat{a}}_{𝒯} , {a}_{𝒯}^{*} )$$
where M_{Θ} is the classifier model which takes [symbol] as input and predicts an outcome [symbol] for each first individual, who belongs to the unknown protected group [symbol] , λ is a hyperparameter, and D_{φ} is the adversarial network that receives the classifier's predictions [symbol] =σ(M_{Θ}( [symbol] )) as input predict groups as [symbol] =σ(D_{φ}( [symbol] )), and wherein group assignments can be estimated according to the following Equation:
$${a}_{𝒯}^{*} = arg max {G}_{Ψ} ( {E}_{φ} ( {x}_{𝒯} ) ) .$$

15. A computer program product comprising at least one non-transitory computer-readable medium including program instructions that, when executed by at least one processor, cause the at least one processor to:
obtain a target data set including a plurality of first individuals, wherein each first individual is associated with a set of first non-protected features and a first binary class label;
obtain a source dataset including a plurality of second individuals, wherein each second individual is associated with a set of second non-protected features, a second binary class label, and a protected feature;
jointly train a target encoder on the target data set and a source encoder on the source data set;
train a protected group estimator model on an output of the source encoder;
after jointly training the target encoder on the target data set and the source encoder on the source dataset and training the protected group estimator model on the output of the source encoder, train the target encoder on the target data set and the protected group estimator model on an output of the target encoder;
after training the target encoder and the protected group estimator model on the target data set, debias a classifier model by:
training the classifier model on the target data set;
generating, with the target encoder and the protected group estimator model, based on the target data set, a plurality of protected features for the plurality of first individuals;
training an adversarial network on an output of the classifier model; and
for each first individual, debiasing the classifier model according to an objective function that depends on the output of the classifier associated with that first individual, the first binary class label associated with that first individual, the output of the adversarial network associated with that first individual, and a protected feature of the plurality of protected features associated with that first individual.

16. The computer program product of claim 15, wherein the plurality of first individuals is different than plurality of second individuals, and wherein the set of first non-protected features is different than the set of second non-protected features.

17. The computer program product of claim 15, wherein the program instructions, when executed by the at least one processor, cause the at least one processor to jointly train the target encoder on the target data set and the source encoder on the source dataset by:
sampling, from the target data set, a first subset of the first individuals associated with the first binary class label including a positive and a second subset of the first individuals associated with the first binary class label including a negative;
sampling, from the source data set, a first subset of the second individuals associated with the second binary class label including a positive and a second subset of the second individuals associate with the second binary class label including a negative;
simultaneously encoding (i) instances of the set of first non-protected features associated with the first subset of the first individuals with the target encoder and (ii) instances of the set of second non-protected features and the protected feature associated with the first subset of the second individuals with the source encoder; and
simultaneously encoding (a) instances of the set of first non-protected features associated with the second subset of the first individuals with the target encoder and (b) instances of the set of second non-protected features and the protected feature associated with the second subset of the second individuals with the source encoder.

18. The computer program product of claim 17, wherein the program instructions, when executed by the at least one processor, cause the at least one processor to jointly train the target encoder on the target data set and the source encoder on the source dataset by optimizing a canonical correlation loss L_{CCA} loss according to the following Equation:
$${ℒ}_{CCA} ( {z}_{𝒮} , {z}_{𝒯} ) = - {\sum }_{i = 1}^{{n}_{𝒮}^{+}} cov ( {z}_{𝒮}^{+ ( i )} , {z}_{𝒯}^{+ ( i )} ) / \sqrt{var ( {z}_{𝒮}^{+ ( i )} ) var ( {z}_{𝒯}^{+ ( i )} )} - {\sum }_{i = 1}^{{n}_{𝒮}^{-}} cov ( {z}_{𝒮}^{- ( i )} {z}_{𝒯}^{- ( i )} ) / \sqrt{var ( {z}_{𝒮}^{- ( i )} ) var ( {z}_{𝒯}^{- ( i )} )}$$
where E_{∂} is the source encoder, [symbol] is an output of the source encoder as [symbol] =E_{∂}( [symbol] ) for an instance of non-protected features [symbol] , E_{φ} is the target encoder, [symbol] is an output of the target encoder as [symbol] =E_{φ}( [symbol] ) for an instance of protected features [symbol] ⊂ [symbol] and [symbol] ⊂ [symbol] are positive subsets of [symbol] and [symbol] of first and second individuals, respectively, [symbol] and [symbol] are negative counterparts of the positive subsets, [symbol] =E_{∂}( [symbol] ) is positive instance of non-protected features transformed by the source encoder, [symbol] =E_{φ}( [symbol] ) is a positive instance of protected features transformed by the target encoder, [symbol] =E_{∂}( [symbol] ) is a negative instance of non-protected features transformed by the source encoder, [symbol] =E_{φ}( [symbol] ) is a negative instance of protected features transformed by the target encoder, wherein minimizing the canonical correlation loss L_{CCA} is equivalent to maximizing according to the following Equation:
$${max}_{ϑ , φ} Tr ( {z}_{𝒮}^{T} , {z}_{𝒯} ) s . t . {z}_{𝒮}^{T} {z}_{𝒮} = {Z}_{𝒯}^{T} {Z}_{𝒯} = I ,$$
where [symbol] =[ [symbol] ] and [symbol] =[ [symbol] ] are corresponding concatenations.

19. The computer program product of claim 18, wherein the program instructions, when executed by the at least one processor, cause the at least one processor to train the protected group estimator model on based the output of the source encoder by minimizing a cross-entropy loss L_{CE} according to the following Equation:
$${ℒ}_{C E} ( {\hat{a}}_{𝒮} , {a}_{𝒮} ) = - {\sum }_{i = 1}^{{n}_{𝒮}} {\sum }_{k = 1}^{K} {a}_{𝒮 , k}^{( i )} log ( {\hat{a}}_{𝒮 , k}^{( i )} )$$
where G_{Ψ} is the protected group estimator model, [symbol] =σ(G_{Ψ}( [symbol] )) is a softmax output of the protected group estimator model for an output of the source encoder as [symbol] for the instance of non-protected features [symbol] with a protected group [symbol] , and K is a number of groups in a domain of the source dataset, such that minimizing the canonical correlation loss L_{CCA} is further defined according to the following equation:
$${min}_{ϑ , φ , Ψ} {ℒ}_{CCA} ( {z}_{𝒮} , {z}_{𝒯} ) + {ℒ}_{CE} ( {\hat{a}}_{𝒮} , {a}_{𝒮} ) .$$

20. The computer program product of claim 19, wherein the program instructions, when executed by the at least one processor, cause the at least one processor to train the target encoder on the target data set and the protected group estimator model on the output of the target encoder by:
computing a consistency loss as a Kullback-Leibler (KL) divergence according to the following Equation:
$${ℒ}_{KLD} ( {\hat{\tilde{a}}}_{𝒯0} , {\hat{a}}_{𝒯0} ) = {\hat{a}}_{𝒯0} \cdot ( log {\hat{a}}_{𝒯0} - log {\hat{\tilde{a}}}_{𝒯0} )$$
where [symbol] =σ(G_{Ψ}( [symbol] )), [symbol] =σ(G_{Ψ}( [symbol] /t)), t is a softmax temperature or function; and
minimizing a cross-entropy loss L_{CE} according to the following Equation:
$${min}_{φ , Ψ} {ℒ}_{C E} ( {\hat{a}}_{𝒯1} , {a}_{𝒯1}^{*} ) + {ℒ}_{KLD} ( {\hat{\tilde{a}}}_{𝒯0} , {\hat{a}}_{𝒯0} )$$
where [symbol] =σ(G_{Ψ}( [symbol] )), m is a masking index, [symbol] /2 is a top half of first individuals with highest probabilities across estimated group categories for which the masking index is set as m=1 to extract corresponding samples as [symbol] = [symbol] [m=1], [symbol] = [symbol] [m=0] is the remaining samples for which the masking index is set as m=0, [symbol] =σ(G_{Ψ}(E_{φ}( [symbol] ))), where [symbol] is a first group of the first individuals extracted by a mask, and [symbol] is a second group of the first individuals remaining after the mask, and pseudo-group labels are generated as [symbol] =arg [symbol] , and
wherein a learning objective for debiasing the classifier model is a min-max problem defined according to the following Equation:
$${min}_{Θ} {max}_{Φ} {ℒ}_{CE} ( {\hat{y}}_{𝒯} , {y}_{𝒯} ) - {λℒ}_{CE} ( {\hat{a}}_{𝒯} , {a}_{𝒯}^{*} )$$
where M_{Θ}is the classifier model which takes [symbol] as input and predicts an outcome [symbol] for each first individual, who belongs to the unknown protected group [symbol] , λ is a hyperparameter, and D_{φ} is the adversarial network that receives the classifier's predictions [symbol] =σ(M_{Θ}( [symbol] )) as input predict groups as [symbol] =σ(D_{φ}( [symbol] )), and wherein group assignments can be estimated according to the following Equation:
$${a}_{𝒯}^{*} = arg max {G}_{Ψ} ( {E}_{φ} ( {x}_{𝒯} ) ) .$$
